(19) United States
(12) Patent Application Publication
(10) Pub. No.: US 2024/0399777 A1
(43) Pub. Date: Dec. 5, 2024

(54) HEAT-SENSITIVE RECORDING BODY

(71) Applicant: Oji Holdings Corporation, Tokyo (JP)

(72) Inventors: Takashi TAKEMURA, Tokyo (JP); Naonobu SUGIYAMA, Tokyo (JP)

(73) Assignee: Oji Holdings Corporation, Tokyo (JP)

(21) Appl. No.: 18/690,905

(22) PCT Filed: Sep. 12, 2022
(86) PCT No.: PCT/JP2022/033984

§ 371 Date: Mar. 11, 2024

(30) Foreign Application Priority Data
Sep. 13, 2021 (JP) 2021-148939
Jul. 6, 2022 (JP) 2022-109089

(51) Int. Cl. B41M 5/333; B41M 5/327; B41M 5/337; B41M 5/41; B41M 5/42

(52) U.S. Cl. CPC B41M 5/3336; B41M 5/3275; B41M 5/3375; B41M 5/41; B41M 5/42; B41M 2205/04; B41M 2205/36

(57) ABSTRACT

Disclosed is a heat-sensitive recording material containing at least an undercoat layer and a heat-sensitive recording layer in this order on a support, the undercoat layer containing hollow particles, a binder, and an inorganic pigment I, the heat-sensitive recording layer containing a leuco dye and a developer, wherein (A) the heat-sensitive recording layer contains 5-(N-3-methylphenyl-sulfonamide)-N′,N″-bis-(3-methylphenyl)-isophthalic acid diamide as a stability improver, or (B) the heat-sensitive recording layer contains 5-(N-3-methylphenyl-sulfonamide)-N′,N″-bis-(3-methylphenyl)-isophthalic acid diamide as the developer and contains a pigment with an oil absorption of 130 ml/100 g or less as an inorganic pigment II.

### TECHNICAL FIELD

The present invention relates to a heat-sensitive recording material that uses a color development reaction between a leuco dye and a developer.

### BACKGROUND ART

Heat-sensitive recording materials, which are in wide practical use, record color images by taking advantage of a heat-induced color development reaction between a colorless or pale-colored leuco dye and a phenol or an organic acid. Such heat-sensitive recording materials have advantages in that, for example, color images can be formed simply by the application of heat, and further, recording devices for these can be compact, can be easily maintained, and generate less noise. For this reason, heat-sensitive recording materials have been used in a broad range of technical fields as information-recording materials for printing devices such as label printers, automatic ticket vending machines, CD/ATMs, order form output devices for use in restaurants etc., data output devices in apparatuses for scientific research, etc.

Since such a color development reaction is a reversible reaction, color images are known to fade with time. This color-fading reaction is accelerated in a high-temperature, high-humidity environment, and further progresses rapidly by contact with oils, plasticizers, etc., and color may fade to such an extent that recorded images become illegible. In recent years, disinfection and sterilization with alcohol have become common practice in general life, especially for the prevention of infectious diseases. Thus, there is an increasing demand for improved performance of heat-sensitive recording materials, such as no color development in the blank-paper portion and no color fading in the printed portion even when they come into contact with alcohol.

For example, Patent Literature (PTL) 1 proposes a heat-sensitive recording material containing a diarylurea derivative as a developer. However, the heat-sensitive recording material described in PTL 1 is insufficient in alcohol resistance and plasticizer resistance, and has room for improvement.

### CITATION LIST

### Patent Literature

PTL 1: WO2019/044462

### SUMMARY OF INVENTION

### Technical Problem

A primary object of the present invention is to provide a heat-sensitive recording material with excellent water plasticizer resistance and water resistance in the recorded portion, and excellent alcohol resistance in the recorded portion and the background portion.

In another embodiment of the present invention, a primary object is to provide a heat-sensitive recording material with excellent alcohol resistance and plasticizer resistance in the recorded portion, as well as excellent thermal background fogging resistance.

### Solution to Problem

In view of the prior art, the present inventors conducted extensive research and found a solution to the problem. More specifically, the present invention provides the following heat-sensitive recording materials.

### Item 1.

A heat-sensitive recording material comprising at least an undercoat layer and a heat-sensitive recording layer in this order on a support,
the undercoat layer containing hollow particles, a binder, and an inorganic pigment I,
the heat-sensitive recording layer containing a leuco dye and a developer,
   wherein
(A) the heat-sensitive recording layer contains 5-(N-3-methylphenyl-sulfonamide)-N′, N″-bis-(3-methylphenyl)-isophthalic acid diamide as a stability improver, or
(B) the heat-sensitive recording layer contains 5-(N-3-methylphenyl-sulfonamide)-N′,N″-bis-(3-methylphenyl)-isophthalic acid diamide as the developer and contains a pigment with an oil absorption of 130 ml/100 g or less as an inorganic pigment II.

### Item 2.

The heat-sensitive recording material according to Item 1, wherein (A) the heat-sensitive recording layer contains 5-(N-3-methylphenyl-sulfonamide)-N′,N″-bis-(3-methylphenyl)-isophthalic acid diamide as the stability improver.

### Item 3.

The heat-sensitive recording material according to Item 2, wherein the developer is a diphenylsulfone derivative represented by the following formula (1):

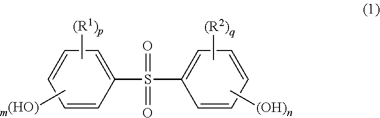

wherein R¹ and R² are the same or different and represent a C₁₋₄ alkyl group, a C₂₋₄ alkenyl group, a C₁₋₄ alkoxy group, a C₂₋₄ alkenyloxy group, a C₇₋₁₂ aralkyloxy group, or a halogen atom, m represents an integer of 0 to 2, n represents an integer of 1 to 3, and p and q are the same or different and represent an integer of 0 to 2.

### Item 4.

The heat-sensitive recording material according to Item 3, wherein the diphenylsulfone derivative represented by formula (1) is at least one member selected from the group consisting of 4-hydroxy-4′-isopropoxy diphenyl sulfone, 4,4′-dihydroxydiphenyl sulfone, 2,4′-dihydroxydiphenyl sulfone, bis(3-allyl-4-hydroxy)diphenyl sulfone, 4-hydroxyphenyl(4′-n-propoxyphenyl) sulfone, 4-allyloxy-4′-hydroxydiphenyl sulfone, and 4-hydroxy-4′-benzyloxydiphenyl sulfone.

### Item 5.

The heat-sensitive recording material according to Item 2, wherein the developer is N-p-tolylsulfonyl-N′-3-(p-tolylsulfonyloxy)phenylurea.

### Item 6.

The heat-sensitive recording material according to Item 2, wherein the developer is N-[2-(3-phenylureid)phenyl]benzenesulfonamide.

### Item 7.

The heat-sensitive recording material according to any one of Items 2 to 6, wherein the content of the stability improver is 0.1 to 4 parts by mass per part by mass of the developer.

### Item 8.

The heat-sensitive recording material according to Item 1, wherein (B) the heat-sensitive recording layer contains 5-(N-3-methylphenyl-sulfonamide)-N′,N″-bis-(3-methylphenyl)-isophthalic acid diamide as the developer and a pigment with an oil absorption of 130 ml/100 g or less as the inorganic pigment II.

### Item 9.

The heat-sensitive recording material according to Item 8, comprising a pigment with an oil absorption of 65 ml/100 g or less as the inorganic pigment II.

### Item 10.

The heat-sensitive recording material according to Item 8 or 9, comprising at least one member selected from the group consisting of calcium carbonate, aluminum hydroxide, and clay as the inorganic pigment II.

### Item 11.

The heat-sensitive recording material according to any one of Items 8 to 10, comprising a pigment with an oil absorption of 130 ml/100 g or less as the inorganic pigment I.

### Item 12.

The heat-sensitive recording material according to any one of Items 8 to 11, comprising at least one member selected from the group consisting of calcium carbonate, aluminum hydroxide, and clay as the inorganic pigment I.

### Item 13.

The heat-sensitive recording material according to any one of Items 8 to 12, wherein the content of the inorganic pigment I is 50 parts by mass or less based on the total solids content of the undercoat layer.

### Item 14.

The heat-sensitive recording material according to any one of Items 8 to 13, wherein the heat-sensitive recording layer contains as a second developer at least one member selected from the group consisting of
a urea urethane compound represented by the following formula (2):

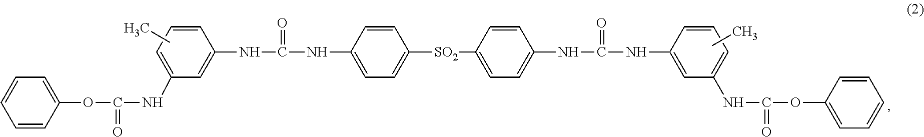

a crosslinked diphenyl sulfone compound represented by the following formula (3):

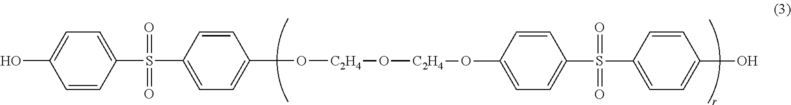

wherein r represents an integer of 1 to 6,
an N,N′-diarylurea-based compound represented by the following formula (4):

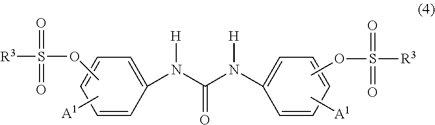

wherein R³ represents a C₁₋₁₂ alkyl group, a C₇₋₁₂ aralkyl group, or a C₆₋₁₂ aryl group, the aralkyl group and the aryl group may optionally be substituted with a C₁₋₁₂ alkyl group, a C₁₋₁₂ alkoxy group, a C₆₋₁₂ aryl group, or a halogen atom, a plurality of R³s may be the same or different, A¹ represents a hydrogen atom or a C₁₋₄ alkyl group, and a plurality of A¹s may be the same or different,
a compound represented by the following formula (5):

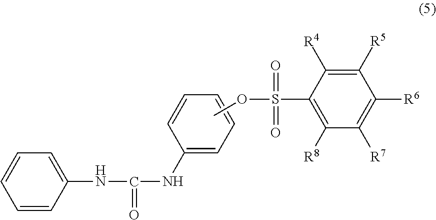

wherein R⁴ to R⁸ are the same or different and represent a hydrogen atom, a halogen atom, a nitro group, an amino group, an alkyl group, an alkoxy group, an aryloxy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group, and
4,4′-bis(3-tosylureid)diphenylmethane.

### Item 15.

The heat-sensitive recording material according to Item 14, comprising the second developer in an amount of 0.2 to 3 parts by mass per part by mass of the leuco dye.

### Item 16.

The heat-sensitive recording material according to any one of Items 1 to 15,

wherein
the hollow particles have a maximum particle diameter (D100) of 10 to 30 μm and an average particle diameter (D50) of 4.0 to 15 μm,
the ratio of the maximum particle diameter (D100) to the average particle diameter (D50), which is D100/D50, is 1.8 to 3.0, and
the volume % of particles with a particle diameter of 2.0 μm or less is 1% or less.

### Item 17.

The heat-sensitive recording material according to any one of Items 1 to 16, wherein the hollow particles have a hollow ratio of 80 to 98%.

### Item 18.

The heat-sensitive recording material according to any one of Items 1 to 17, wherein the binder in the undercoat layer contains a binder resin with a glass transition temperature of −10° C. or lower.

### Item 19.

The heat-sensitive recording material according to any one of Items 1 to 17, wherein the binder in the undercoat layer contains a binder resin with a glass transition temperature of −30° C. or lower.

### Item 20.

The heat-sensitive recording material according to any one of Items 1 to 19, further comprising an adhesive layer on at least one surface of the support.

### Advantageous Effects of Invention

The heat-sensitive recording material of the present invention has excellent water plasticizer resistance and water resistance in the recorded portion, and excellent alcohol resistance in the recorded portion and the background portion.

The heat-sensitive recording material in another embodiment of the present invention has excellent alcohol resistance and plasticizer resistance in the recorded portion, and excellent thermal background fogging resistance. The heat-sensitive recording material can also increase the color density.

### DESCRIPTION OF EMBODIMENTS

In the present specification, the expression “comprise” or “contain” includes the concepts of comprising, consisting essentially of, and consisting of.

In the present specification, a numerical range indicated by “ . . . to . . . ” means a range including the numerical values given before and after “to” as the lower limit and the upper limit.

“Latex” as used herein includes one in the form of a gel or dry film formed by drying a dispersion medium.

In the present invention, the average particle diameter refers to a median size on a volumetric basis as measured according to laser diffractometry. More simply, the average particle diameter may be indicated by the average of ten particles determined by measuring their particle diameter in a particle image (SEM image) with an electron microscope.

The present invention relates to a heat-sensitive recording material comprising at least an undercoat layer and a heat-sensitive recording layer in this order on a support,
the undercoat layer containing hollow particles, a binder, and an inorganic pigment I,
the heat-sensitive recording layer containing a leuco dye and a developer,
   wherein
(A) the heat-sensitive recording layer contains 5-(N-3-methylphenyl-sulfonamide)-N′,N″-bis-(3-methylphenyl)-isophthalic acid diamide as a stability improver, or
(B) the heat-sensitive recording layer contains 5-(N-3-methylphenyl-sulfonamide)-N′,N″-bis-(3-methylphenyl)-isophthalic acid diamide as the developer and contains a pigment with an oil absorption of 130 ml/100 g or less as an inorganic pigment II.

A heat-sensitive recording material having the characteristics (A) and a heat-sensitive recording material having the characteristics (B) are respectively denoted as heat-sensitive recording material (A) and heat-sensitive recording material (B), and are described in detail below.

### A. Heat-sensitive Recording Material (A)

In the present invention, the heat-sensitive recording material comprises an undercoat layer containing hollow particles, a binder, and an inorganic pigment I on a support, and a heat-sensitive recording layer containing a leuco dye, a developer, and a binder on the undercoat, wherein the heat-sensitive recording layer contains 5-(N-3-methylphenyl-sulfonamide)-N′,N″-bis-(3-methylphenyl)-isophthalic acid diamide as a stability improver.

### Support

The support in the present invention is not particularly limited in type, shape, dimension, or the like. For example, high-quality paper (acid paper, neutral paper), medium-quality paper, coated paper, art paper, cast-coated paper, glassine paper, resin laminate paper, polyolefin-based synthetic paper, synthetic fiber paper, nonwoven fabrics, synthetic resin films, various transparent supports, or the like, can be appropriately selected and used. The thickness of the support is not particularly limited, and is typically about 20 to 200 μm. The density of the support is not particularly limited, and is preferably about 0.60 to 0.85 g/cm³.

### Undercoat Layer

The heat-sensitive recording material of the present invention comprises an undercoat layer between a support and a heat-sensitive recording layer, and the undercoat layer contains hollow particles, a binder, and an inorganic pigment I.

### Hollow Particles

The hollow particles are preferably formed of an organic resin from the viewpoint of enhancing cushioning properties. The undercoat layer that contains the hollow particles and thus has excellent heat-insulating properties can prevent the diffusion of heat applied to the heat-sensitive recording layer and increase the sensitivity of the heat-sensitive recording material.

Hollow particles formed of an organic resin can be divided into foamed and non-foamed types depending on the production method. Of these two types, foamed-type hollow particles typically have a larger average particle diameter and a higher hollow ratio than non-foamed-type hollow particles. Thus, foamed-type hollow particles allow for better sensitivity and image quality than non-foamed-type hollow particles.

Non-foamed-type hollow particles can be produced by polymerizing a seed in a solution, polymerizing another resin so as to cover the seed, and removing the seed inside by swelling and dissolving to form a void inside. An alkaline aqueous solution or the like is used to remove the seed inside by swelling and dissolving. Non-foamed-type hollow particles with a relatively large average particle diameter can also be produced by alkaline swelling treatment of core-shell particles in which core particles having alkaline swelling properties are coated with a shell layer that does not have alkaline swelling properties.

Foamed-type hollow particles can be produced by preparing particles in which a volatile liquid is sealed in a resin, and vaporizing and expanding the liquid in the particles while softening the resin by heating.

In the process of producing foamed-type hollow particles, the liquid in the particles is expanded by heating, thereby increasing the hollow ratio and providing excellent heat-insulating properties; thus, use of foamed-type hollow particles can enhance the sensitivity of the heat-sensitive recording material and improve the recording density. The improvement in sensitivity is particularly important in color development in a medium energy range, in which the thermal energy applied to the heat-sensitive recording layer is small. In addition, when the heat-sensitive recording layer is formed via an undercoat layer with excellent heat-insulating properties, the diffusion of heat applied to the heat-sensitive recording layer is prevented, resulting in excellent image uniformity and improved image quality. Thus, in this embodiment, it is preferable to use foamed-type hollow particles, which are excellent in improvement in the heat-insulating properties of the undercoat layer.

Examples of the resin that can be used for foamed-type hollow particles include thermoplastic resins, such as styrene-acrylic resins, polystyrene resins, acrylic resins, polyethylene resins, polypropylene resins, polyacetal resins, chlorinated polyether resins, polyvinyl chloride resins, polyvinylidene chloride resins, acrylic-based resins (e.g., an acrylic-based resin containing acrylonitrile as a component), styrene-based resins, vinylidene chloride-based resins, and copolymer resins mainly formed of polyvinylidene chloride and acrylonitrile. As gases contained in foamed-type hollow particles, propane, butane, isobutane, air, etc. can be typically used. Of the various resins, acrylonitrile resins and copolymer resins mainly formed of polyvinylidene chloride and acrylonitrile are preferred as resins that can be used for the hollow particles, from the viewpoint of the strength to maintain the shape of foamed particles.

The maximum particle diameter of the hollow particles in the present invention is preferably 10 to 30 μm, more preferably 10 to 25 μm, and even more preferably 10 to 20 μm. The maximum particle diameter is also referred to as “D100.” When the maximum particle diameter of the hollow particles is 10 μm or more, the cushioning properties of the undercoat layer are improved; thus, the adhesion of the heat-sensitive recording material to a thermal head during printing is improved, and a heat-sensitive recording material with high image quality is obtained. This high image quality can result in improved recording density in a medium energy range, in which color is developed with energy lower than that for providing the maximum recording density (Dmax). When the maximum particle diameter of the hollow particles is 30 μm or less, the smoothness of the undercoat layer is improved; thus, the heat-sensitive recording layer provided via the undercoat layer can be made uniform, and a heat-sensitive recording material in which formation of white spots in an image is less likely to occur can be obtained.

The average particle diameter of the hollow particles in the present invention is preferably 4.0 to 15 μm, and more preferably 4.5 to 15 μm. The average particle diameter as used herein is the diameter at which the volume of larger particles is equal to the volume of smaller particles when particles are divided into two kinds based on the particle diameter, i.e., the median diameter, which is the particle diameter corresponding to 50 volume % frequency. The average particle diameter is also referred to as “D50.” When the average particle diameter of the hollow particles is 4.0 μm or more, the cushioning properties of the undercoat layer are improved; thus, the adhesion of the heat-sensitive recording material to a thermal head during printing is improved, and a heat-sensitive recording material with high image quality is obtained. This high image quality can result in improved recording density in a medium energy range, in which color is developed with energy lower than that for providing the maximum recording density (Dmax). When the average particle diameter of the hollow particles is 15 μm or less, the smoothness of the undercoat layer is improved; thus, the heat-sensitive recording layer provided via the undercoat layer can be made uniform, and a heat-sensitive recording material in which formation of white spots in an image is less likely to occur can be obtained.

The maximum particle diameter (D100) and average particle diameter (D50) of the hollow particles can be measured using a laser diffraction particle diameter distribution analyzer. The average particle diameter (D50) may be shown according to the average value of particle diameters of 10 particles, the particle diameters being measured from the image of each particle with an electron microscope (SEM image).

The ratio of the maximum particle diameter (D100) of the hollow particles to the average particle diameter (D50) of the hollow particles, i.e., D100/D50, is an index showing the degree of particle diameter distribution. The D100/D50 ratio is preferably 1.8 to 3.0, and more preferably 2.0 to 2.8. When the D100/D50 ratio of the hollow particles is 1.8 or more, the hollow particles can be sufficiently foamed, the maximum particle diameter can be sufficiently large, the hollow ratio can be high, and the heat-insulating properties of the undercoat layer can be improved. When the D100/D50 ratio of the hollow particles is 3.0 or less, the sizes of the hollow particles are uniform, which improves the smoothness of the undercoat layer and suppresses white spots in an image.

In a particle diameter distribution, the volume % of hollow particles having a particle diameter of 2.0 μm or less is preferably 1% or less. The particle diameter distribution can be determined with a laser diffraction particle diameter distribution analyzer. The particle diameter distribution can also be determined by measuring particle diameter in a particle image (SEM image) with an electron microscope. It is also preferred that the volume % of hollow particles having a particle diameter of 2.0 μm or less is 0.5% or less, and it is more preferred that hollow particles having a particle diameter of 2.0 μm or less are not contained. Hollow particles having a particle diameter of 2 μm or less are considered to have a very small contribution to heat-insulating properties because they are too small to have a sufficient hollow area. When the volume % of hollow particles having a particle diameter of 2 μm or less in the undercoat layer is 1% or less, the recording density, image quality, etc. can be improved.

The hollow ratio of the hollow particles is preferably 80 to 98%, and more preferably 90 to 98%. When the hollow ratio of the hollow particles is 80% or higher, excellent heat-insulating properties can be imparted to the undercoat layer containing the hollow particles. This improves the recording density for the preferable developer described later, while allowing the effects of the stability improver in the present invention to be fully brought about at the same time. When the hollow ratio of the hollow particles is 98% or less, the strength of the film surrounding the hollow portion is improved, and thus hollow particles that do not collapse even when the undercoat layer is formed can be obtained.

The hollow ratio of the hollow particles is determined by measuring the true specific gravity according to the IPA method, and using the true specific gravity value as follows.

### (1) Sample Pretreatment

A sample is dried at 60° C. around the clock.

### (2) Reagent

Isopropyl alcohol (IPA: extra-pure reagent)

### (3) Measurement Method

A volumetric flask is weighed (W1).
About 0.5 g of the dried sample is weighed in the volumetric flask (W2).
About 50 mg of IPA is added thereto, and the volumetric flask is fully shaken to completely remove air outside the capsule.
IPA is added to the marked line, and the volumetric flask is weighed (W3).
As a blank, IPA alone is added to the marked line of a volumetric flask, and the volumetric flask is weighed (W4).

$$Calculation of true specific gravity \qquad ( 4 )$$

$$True specific gravity = \{ ( W 2 - W 1 ) \times ( ( W 4 - W 1 ) / 100 ) \} / \{ ( W 4 - W 1 ) - ( W 3 - W 2 ) \}$$

$$Calculation of hollow ratio \qquad ( 5 )$$

$$Hollow ratio ( \% ) = \{ 1 - 1 / ( 1.1 / true specific gravity ) \} \times 100$$

The hollow ratio is a value that can also be determined according to the following formula: (d³/D³)×100. In the formula, d represents the inner diameter of the hollow particles, and D represents the outer diameter of the hollow particles.

Since the hollow particles in the present invention have a relatively large particle diameter, the content of the hollow particles in the undercoat layer can be reduced. The content of the hollow particles is preferably 3 to 40 mass %, and more preferably 5 to 35 mass %, based on the total solids content of the undercoat layer. A hollow particle content of 3 mass % or higher can improve the heat-insulating properties of the undercoat layer, whereas a hollow particle content of 40 mass % or less makes it less likely to cause problems in terms of coating properties and the like, and makes it possible to easily form a uniform undercoat layer and improve the recording density. Further, the coating film strength of the undercoat layer can be increased.

### Binder

Examples of binders include water-soluble polymeric materials, such as polyvinyl alcohol and derivatives thereof, starch and derivatives thereof, cellulose derivatives, such as hydroxymethylcellulose, hydroxyethylcellulose, hydroxypropylcellulose, methylcellulose, ethylcellulose, and carboxymethylcellulose, sodium polyacrylate, polyvinylpyrrolidone, acrylamide-acrylic acid ester copolymers, acrylamide-acrylic acid ester-methacrylic acid ester copolymers, styrene-maleic anhydride copolymers, isobutylene-maleic anhydride copolymers, casein, gelatin, and derivatives thereof; emulsions, such as polyvinyl acetate, polyurethane, polyacrylic acid, polyacrylic acid ester, vinyl chloride-vinyl acetate copolymers, polybutyl methacrylate, ethylene-vinyl acetate copolymers, and the like; latexes of water-insoluble polymers, such as styrene-butadiene copolymers and styrene-butadiene-acrylic copolymers; and the like. Of these, it is preferable to use a binder containing a latex. The content of the binder can be selected from a wide range, and is typically preferably about 20 to 70 mass %, and more preferably about 25 to 60 mass %, based on the total solids content of the undercoat layer.

The binder preferably contains a binder resin with a glass transition temperature (Tg) of −10° C. or lower. When the glass transition temperature is −10° C. or lower, image quality can be improved even in a low energy range. The glass transition temperature is more preferably −30° C. or lower because image quality can be further improved in a low energy range. A glass transition temperature of −50° C. or lower is not preferable because stickiness occurs. Thus, the glass transition temperature is preferably −40° C. or higher.

### Inorganic Pigment I

The undercoat layer of the present invention contains an inorganic pigment I. The oil absorption of the inorganic pigment I is preferably 150 ml/100 g or less, more preferably 130 ml/100 g or less, and even more preferably 125 ml/100 g or less, from the viewpoint of increasing recording density and improving water plasticizer resistance and alcohol resistance. The oil absorption of the inorganic pigment I is also preferably 50 ml/100 g or more, more preferably 70 ml/100 g or more, and even more preferably 80 ml/100 g or more from the viewpoint of effectively reducing printing problems such as head residue and sticking. The oil absorption is a value determined according to the method of JIS K 5101.

Various inorganic pigments can be used as the inorganic pigment I, and specific examples include calcined kaolin, amorphous silica, light calcium carbonate, talc, kaolin, and clay. The primary particles of these inorganic pigments I preferably have an average particle diameter of about 0.01 to 5 μm, and more preferably about 0.02 to 3 μm. The content of the inorganic pigment I is preferably 60 mass % or less, and more preferably 50 mass % or less, based on the total solids content of the undercoat layer, from the viewpoint of improving water plasticizer resistance and alcohol resistance. The content of the inorganic pigment I is also preferably 20 mass % or higher, and more preferably 25 mass % or higher, based on the total solids content of the undercoat layer, from the viewpoint of effectively reducing printing problems such as head residue and sticking.

The undercoat layer is formed on a support, for example, by mixing the hollow particles, the binder, and the inorganic pigment I, and if necessary, auxiliary agents, and the like using water as a medium to prepare a coating composition for an undercoat layer, applying the coating composition to the support, and then drying. The amount of the coating composition for an undercoat layer is not particularly limited, and is preferably about 2 to 20 g/m², more preferably about 2 to 12 g/m², and even more preferably about 3 to 8 g/m² in terms of dry mass.

### Heat-Sensitive Recording Layer

### Leuco Dye

The heat-sensitive recording layer of the heat-sensitive recording material of the present invention may contain any of various known colorless or pale-colored leuco dyes. Specific examples of such leuco dyes are described below.

Specific examples of leuco dyes include dyes capable of developing blue color, such as 3,3-bis(p-dimethylaminophenyl)-6-dimethylaminophthalide, 3-(4-diethylamino-2-methylphenyl)-3-(4-dimethylaminophenyl)-6-dimethylaminophthalide, and fluoran; dyes capable of developing green color, such as 3-(N-ethyl-N-p-tolyl)amino-7-N-methylanilinofluoran, 3-diethylamino-7-anilinofluoran, 3-diethylamino-7-dibenzylaminofluoran, and rhodamine B-anilinolactam; dyes capable of developing red color, such as 3,6-bis(diethylamino)fluoran-γ-anilinolactam, 3-cyclohexylamino-6-chlorofluoran, 3-diethylamino-6-methyl-7-chlorofluoran, and 3-diethylamino-7-chlorofluoran; dyes capable of developing black color, such as 3-(N-ethyl-N-isoamyl)amino-6-methyl-7-anilinofluoran, 3-(N-methyl-N-cyclohexyl)amino-6-methyl-7-anilinofluoran, 3-diethylamino-6-methyl-7-anilinofluoran, 3-di(n-butyl)amino-6-methyl-7-anilinofluoran, 3-di(n-pentyl)amino-6-methyl-7-anilinofluoran, 3-(N-ethyl-N-isoamylamino)-6-methyl-7-alininofluoran, 3-diethylamino-7-(m-trifluoromethylanilino)fluoran, 3-(N-isoamyl-N-ethylamino)-7-(o-chloroanilino)fluoran, 3-(N-ethyl-N-2-tetrahydrofurfurylamino)-6-methyl-7-anilinofluoran, 3-(N-n-hexyl-N-ethylamino)-6-methyl-7-anilinofluoran, 3-[N-(3-ethoxypropyl)-N-ethylamino]-6-methyl-7-anilinofluoran, 3-[N-(3-ethoxypropyl)-N-methylamino]-6-methyl-7-anilinofluoran, 3-diethylamino-7-(2-chloroanilino)fluoran, 3-di(n-butylamino)-7-(2-chloroanilino)fluoran, 4,4′-bis-dimethylaminobenzhydrinbenzyl ether, N-2,4,5-trichlorophenylleucooramine, 3-diethylamino-7-butylaminofluoran, 3-ethyl-tolylamino-6-methyl-7-anilinofluoran, 3-cyclohexyl-methylamino-6-methyl-7-anilinofluoran, 3-diethylamino-6-chloro-7-(β-ethoxyethyl)aminofluoran, 3-diethylamino-6-chloro-7-(γ-chloropropyl)aminofluoran, 3-diethylamino-6-methyl-7-anilinofluoran, 3-(N-isoamyl-N-ethylamino)-6-methyl-7-anilinofluoran, 3-dibutylamino-7-chloroanilinofluoran, 3-diethylamino-7-(o-chlorophenylamino)fluoran, 3-(N-ethyl-p-toluidino)-6-methyl-7-anilinofluoran, 3-(N-ethyl-p-toluidino)-6-methyl-7-(p-toluidino)fluoran, 3-(N-ethyl-N-tetrahydrofurfurylamino)-6-methyl-7-anilinofluoran, 3-diethylamino-6-chloro-7-anilinofluoran, 3-dimethylamino-6-methyl-7-anilinofluoran, 3-pyrrolidino-6-methyl-7-anilinofluoran, 3-piperidino-6-methyl-7-anilinofluoran, 2,2-bis{4-[6′-(N-cyclohexyl-N-methylamino)-3′-methylspiro[phthalide-3,9′-xanthen-2′-ylamino]phenyl}propane, and 3-diethylamino-7-(3′-trifluoromethylphenyl)aminofluoran; dyes having absorption wavelengths in the near-infrared region, such as 3,3-bis[1-(4-methoxyphenyl)-1-(4-dimethylaminophenyl)ethylen-2-yl]-4,5,6,7-tetrachlorophthalide, 3,3-bis[1-(4-methoxyphenyl)-1-(4-pyrrolidinophenyl)ethylen-2-yl]-4,5,6,7-tetrachlorophthalide, 3-p-(p-dimethylaminoanilino)anilino-6-methyl-7-chlorofluoran, 3-p-(p-chloroanilino)anilino-6-methyl-7-chlorofluoran, and 3,6-bis(dimethylamino)fluorene-9-spiro-3′-(6′-dimethylamino)phthalide; and the like. Usable leuco dyes are, of course, not limited to these compounds, and two or more of such compounds can be used in combination as necessary.

The content of the leuco dye is not particularly limited, and is preferably about 3 to 30 mass %, more preferably about 5 to 25 mass %, and even more preferably about 7 to 20 mass %, based on the total solids content of the heat-sensitive recording layer. A leuco dye content of 3 mass % or higher can enhance color development ability and thus improve recording density, whereas a leuco dye content of 30 mass % or less can enhance heat resistance.

### Developer

Specific examples of developers include phenolic compounds, such as 4-tert-butylphenol, 4-acetylphenol, 4-tert-octylphenol, 4,4′-sec-butylidenediphenol, 4-phenylphenol, 4,4′-dihydroxydiphenylmethane, 4,4′-isopropylidenediphenol, 4,4′-cyclohexylidenediphenyl, 4,4′-cyclohexylidenediphenol, 1,1-bis(4-hydroxyphenyl)-ethane, 1,1-bis(4-hydroxyphenyl)-1-phenylethane, 4,4′-bis(p-tolylsulfonylaminocarbonylamino)diphenylmethane, 1,1-bis(4-hydroxyphenyl)cyclohexane, 2,2′-bis[4-(4-hydroxyphenyl)phenoxy]diethyl ether, 4,4′-dihydroxydiphenylsulfide, 4,4′-thiobis(3-methyl-6-tert-butylphenol), 4,4′-dihydroxydiphenylsulfone, 2,4′-dihydroxydiphenylsulfone, 2,2-bis(4-hydroxyphenyl)-4-methylpentane, 2,4′-dihydroxydiphenylsulfone, 4-hydroxy-4′-isopropoxy diphenyl sulfone, 4-hydroxy-4′-n-propoxydiphenylsulfone, 4-hydroxy-4′-allyloxydiphenylsulfone, 4-hydroxy-4′-benzyloxydiphenyl sulfone, 3,3′-diallyl-4,4′-dihydroxydiphenylsulfone, butyl bis(p-hydroxyphenyl)acetate, methyl bis(p-hydroxyphenyl)acetate, hydroquinone monobenzyl ether, bis(3-allyl-4-hydroxyphenyl)sulfone, 4-hydroxy-4′-methyldiphenylsulfone, 4-allyloxy-4′-hydroxydiphenylsulfone, 3,4-dihydroxyphenyl-4′-methylphenylsulfone, 4-hydroxybenzophenone, dimethyl 4-hydroxyphthalate, methyl 4-hydroxybenzoate, propyl 4-hydroxybenzoate, sec-butyl 4-hydroxybenzoate, phenyl 4-hydroxybenzoate, benzyl 4-hydroxybenzoate, 4-hydroxybenzoic acid benzyl ester, tolyl 4-hydroxybenzoate, chlorophenyl 4-hydroxybenzoate, and 4,4′-dihydroxydiphenyl ether; aromatic carboxylic acids, such as benzoic acid, p-chlorobenzoic acid, p-tert-butylbenzoic acid, tolylchlorobenzoic acid, terephthalic acid, salicylic acid, 3-tert-butylsalicylic acid, 3-isopropylsalicylic acid, 3-benzylsalicylic acid, 3-(α-methylbenzyl)salicylic acid, 3,5-di-tert-butylsalicylic acid, 4-[2-(p-methoxyphenoxy)ethyloxy]salicylic acid, 4-[3-(p-tolylsulfonyl)propyloxy]salicylic acid, 5-[p-(2-p-methoxyphenoxyethoxy)cunyl]salicylic acid, and zinc 4-[3-(p-tolylsulfonyl)propyloxy]salicylate; salts of these phenolic compounds or aromatic carboxylic acids with, for example, polyvalent metals, such as zinc, magnesium, aluminum, calcium, titanium, manganese, tin, and nickel; antipyrine complex of zinc thiocyanate; organic acidic substances, such as composite zinc salts of terephthalic aldehyde acid and other aromatic carboxylic acids; thiourea compounds, such as N-p-toluenesulfonyl-N′-3-(p-toluenesulfonyloxy)phenylurea, N-p-toluenesulfonyl-N′-p-butoxycarbonylphenylurea, N-p-tolylsulfonyl-N′-phenylurea, and N,N′-di-m-chlorophenylthiourea; organic compounds having a —SO₂NH—bond in the molecule, such as N-(p-toluenesulfonyl)carbamic acid p-cumylphenyl ester, N-(p-toluenesulfonyl) carbamic acid p-benzyloxyphenyl ester, N-[2-(3-phenylureido)phenyl]benzenesulfonamide, and N-(o-toluoyl)-p-toluenesulfoamide; inorganic acidic substances, such as activated clay, attapulgite, colloidal silica, and aluminum silicate; and the like. The developer is of course not limited to these, and the developer for use may be a combination of two or more compounds as necessary.

In the present invention, the developer is preferably a diphenylsulfone derivative represented by the following formula (1). This allows the effects of the present invention to be fully brought about.

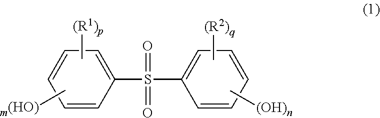

wherein R¹ and R² are the same or different and represent a C₁₋₄ alkyl group, a C₂₋₄ alkenyl group, a C₁₋₄ alkoxy group, a C₂₋₄ alkenyloxy group, a C₇₋₁₂ aralkyloxy group, or a halogen atom, m represents an integer of 0 to 2, n represents an integer of 1 to 3, and p and q are the same or different and represent an integer of 0 to 2.

In formula (1), the C₁₋₄ alkyl group for R¹ or R² may be linear or branched, and examples include a methyl group, an ethyl group, a propyl group, an isopropyl group, a butyl group, an isobutyl group, a sec-butyl group, and a t-butyl group. The alkyl group as used herein also includes the alkyl moiety of a C₁₋₄ alkoxy group. The C₂₋₄ alkenyl group may be linear or branched, and examples include a vinyl group, an n-propenyl group (allyl group), and an n-butenyl group. The alkenyl group as used herein also includes the alkenyl moiety of a C₂₋₄ alkenyloxy group. The aralkyl group refers to an aryl alkyl group, and examples of a C₇₋₁₂ aralkyl group include a benzyl group, a 1-phenylethyl group, a 2-phenylethyl group, and a 3-phenylpropyl group. The halogen atom includes fluorine, chlorine, bromine, and iodine. If there are a plurality of R's and/or R²s, they may be the same or different. The position of substitution of R¹, R², or OH is not particularly limited, and the 3-position, 4-position, or 5-position is preferable.

m is preferably 0 or 1, n is preferably 1, and p and q are preferably the same or different and 0 or 1.

The diphenylsulfone derivative represented by formula (1) is not particularly limited and is preferably at least one member selected from the group consisting of 4-hydroxy-4′-isopropoxy diphenyl sulfone, 4,4′-dihydroxydiphenyl sulfone, 2,4′-dihydroxydiphenyl sulfone, bis(3-allyl-4-hydroxy)diphenyl sulfone, 4-hydroxyphenyl(4′-n-propoxyphenyl) sulfone, 4-allyloxy-4′-hydroxydiphenyl sulfone, and 4-hydroxy-4′-benzyloxydiphenyl sulfone.

In the present invention, the developer is also preferably N-p-tolylsulfonyl-N′-3-(p-tolylsulfonyloxy)phenylurea. This allows the effects of the present invention to be fully brought about.

In the present invention, the developer is also preferably N-[2-(3-phenylureid)phenyl]benzenesulfonamide. This allows the effects of the present invention to be fully brought about.

The content of the developer is not particularly limited and can be adjusted according to the leuco dye for use. Typically, the content of the developer is preferably 0.5 parts by mass or more, more preferably 0.8 parts by mass or more, still more preferably 1 part by mass or more, even more preferably 1.2 parts by mass or more, and particularly preferably 1.5 parts by mass or more, per part by mass of the leuco dye. The content of the developer is also preferably 10 parts by mass or less, more preferably 5 parts by mass or less, still more preferably 4 parts by mass or less, and particularly preferably 3.5 parts by mass or less, per part by mass of the leuco dye. A content of the developer of 0.5 parts by mass or more can enhance recording performance, whereas a content of 10 parts by mass or less can effectively decrease background fogging in a high-temperature environment.

The heat-sensitive recording layer of the present invention contains 5-(N-3-methylphenyl-sulfonamide)-N′,N″-bis-(3-methylphenyl)-isophthalic acid diamide as a stability improver. Due to this, the heat-sensitive recording material of the present invention has excellent water plasticizer resistance and water resistance in the recorded portion, and excellent alcohol resistance in the recorded portion and background portion.

The content of 5-(N-3-methylphenyl-sulfonamide)-N′,N″-bis-(3-methylphenyl)-isophthalic acid diamide as a stability improver is not particularly limited, and can be adjusted according to the developer for use. Typically, the content of 5-(N-3-methylphenyl-sulfonamide)-N′,N″-bis-(3-methylphenyl)-isophthalic acid diamide is preferably about 0.1 to 4 parts by mass, more preferably about 0.10 to 3 parts by mass, still more preferably about 0.10 to 2 parts by mass, even more preferably about 0.15 to 1 part by mass, and particularly preferably about 0.15 to 1.0 part by mass, per part by mass of the developer. A content of 0.1 parts by mass or more can enhance the water plasticizer resistance and water resistance of the recorded portion and the alcohol resistance of the recorded portion, whereas a content of 4 parts by mass or less can enhance recording density.

In the present invention, it is preferred that the following compounds are not present as a stability improver: a urea urethane compound represented by the following formula (2), such as 4,4′-bis[(4-methyl-3-phenoxycarbonylaminophenyl)ureid]diphenylsulfone, 4,4′-bis[(2-methyl-5-phenoxycarbonylaminophenyl)ureid]diphenylsulfone, and 4-(2-methyl-3-phenoxycarbonylaminophenyl) ureid-4′-(4-methyl-5-phenoxycarbonylaminophenyl)ureid diphenylsulfone, and a crosslinked diphenyl sulfone compound represented by the following formula (3).

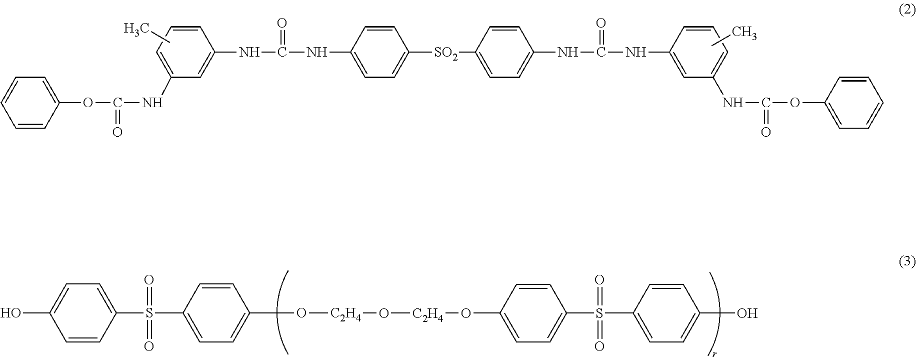

(wherein r represents an integer of 1 to 6).

Optionally, the heat-sensitive recording layer may further contain a stabilizer mainly in order to further enhance the preservation of the developed color image to the extent that the effects of the present invention are not impaired. As such a stabilizer, it is possible to use, for example, at least one member selected from the group consisting of phenol compounds, such as 1,1,3-tris(2-methyl-4-hydroxy-5-cyclohexylphenyl)butane, 1,1,3-tris(2-methyl-4-hydroxy-5-tert-butylphenyl)butane, 1,1-bis(2-methyl-4-hydroxy-5-tert-butylphenyl)butane, 4,4′-[1,4-phenylenebis(1-methylethylidene)]bisphenol, and 4,4′-[1,3-phenylenebis(1-methylethylidene)]bisphenol; epoxy compounds, such as 4-benzyloxyphenyl-4′-(2-methyl-2,3-epoxypropyloxy)phenylsulfone, 4-(2-methyl-1,2-epoxyethyl)diphenylsulfone, and 4-(2-ethyl-1,2-epoxyethyl)diphenylsulfone; and isocyanuric acid compounds, such as 1,3,5-tris(2,6-dimethylbenzyl-3-hydroxy-4-tert-butyl)isocyanuric acid. Usable stabilizers are, of course, not limited to these compounds, and two or more of such compounds can be used in combination as necessary.

When the stabilizer is used, its amount may be an effective amount for improving image preservation. The stabilizer is typically preferably used in an amount of about 1 to 25 mass %, and more preferably about 5 to 20 mass %, based on the total solids content of the heat-sensitive recording layer.

In the present invention, the heat-sensitive recording layer may further contain a sensitizer. Use of the sensitizer enhances the recording sensitivity. Examples of usable sensitizers include stearic acid amide, methoxycarbonyl-N-stearic acid benzamide, N-benzoyl stearic acid amide, N-eicosanoic acid amide, ethylenebisstearic acid amide, behenic acid amide, methylenebisstearic acid amide, N-methylol stearic acid amide, dibenzyl terephthalate, dimethyl terephthalate, dioctyl terephthalate, diphenylsulfone, benzyl p-benzyloxybenzoate, phenyl 1-hydroxy-2-naphthoate, 2-naphthyl benzyl ether, m-terphenyl, p-benzylbiphenyl, oxalic acid-di-p-chlorobenzyl ester, oxalic acid-di-p-methylbenzyl ester, oxalic acid-dibenzyl ester, p-tolyl biphenyl ether, di(p-methoxyphenoxyethyl)ether, 1,2-di(3-methylphenoxy)ethane, 1,2-di(4-methylphenoxy)ethane, 1,2-di(4-methoxyphenoxy)ethane, 1,2-di(4-chlorophenoxy)ethane, 1,2-diphenoxyethane, 1-(4-methoxyphenoxy)-2-(3-methylphenoxy)ethane, p-methylthiophenylbenzylether, 1,4-di(phenylthio)butane, p-acetotoluidide, p-acetophenetidide, N-acetoacetyl-p-toluidine, 1,2-diphenoxymethylbenzene, di(β-biphenylethoxy)benzene, p-di(vinyloxyethoxy)benzene, 1-isopropylphenyl-2-phenylethane, di-o-chlorobenzyl adipate, 1,2-bis(3,4-dimethylphenyl)ethane, 1,3-bis(2-naphthoxy)propane, diphenyl, benzophenone, and the like. Of these, 1,2-di(3-methylphenoxy)ethane is preferred from the viewpoint of obtaining a sensitizing effect without reducing water plasticizer resistance and alcohol resistance. These sensitizers can be used in combination as long as the combined use does not impair the effects of the present invention. The sensitizer content may be an effective amount for sensitization, and is typically preferably about 2 to 25 mass %, more preferably about 5 to 20 mass %, and even more preferably about 5 to 15 mass %, based on the total solids content of the heat-sensitive recording layer.

As other components that constitute the heat-sensitive recording layer, a binder can be used. Further, if necessary, auxiliary agents, such as pigments, crosslinking agents, waxes, metal soaps, water resistance improving agents, dispersants, colored dyes, and fluorescent dyes can be used.

Examples of binders include water-soluble polymeric materials, such as polyvinyl alcohol and derivatives thereof, starch and derivatives thereof, cellulose derivatives, such as hydroxymethylcellulose, hydroxyethylcellulose, hydroxypropylcellulose, methylcellulose, and ethylcellulose, sodium polyacrylate, polyvinylpyrrolidone, acrylamide-acrylic acid ester copolymers, acrylamide-acrylic acid ester-methacrylic acid ester copolymers, styrene-maleic anhydride copolymers, isobutylene-maleic anhydride copolymers, casein, gelatin, and derivatives thereof; emulsions, such as polyvinyl acetate, polyurethane, polyacrylic acid, polyacrylic acid ester, vinyl chloride-vinyl acetate copolymers, polybutyl methacrylate, ethylene-vinyl acetate copolymers, and the like; latexes of water-insoluble polymers, such as styrene-butadiene copolymers and styrene-butadiene-acrylic copolymers; and the like. Of these, polyvinyl alcohol, latexes, and the like are preferred. The content of the binder can be selected from a wide range, and is typically preferably about 5 to 30 mass %, and more preferably about 10 to 20 mass %, based on the total solids content of the heat-sensitive recording layer.

When the heat-sensitive recording layer contains a crosslinking agent, the water resistance of the heat-sensitive recording layer can be improved. Examples of crosslinking agents include aldehyde compounds, such as glyoxal; polyamine compounds, such as polyethyleneimine; epoxy compounds, polyamide resins, melamine resins, glyoxylic acid salts, dimethylolurea compounds, aziridine compounds, block isocyanate compounds; and inorganic compounds, such as ammonium persulfate, ferric chloride, magnesium chloride, soda tetraborate, and potassium tetraborate; and boric acid, boric acid triesters, boron polymers, hydrazide compounds, glyoxylic acid salts, and the like. These may be used singly, or in a combination of two or more. The amount of the crosslinking agent used is preferably about 1 to 10 mass %, and more preferably about 2 to 8 mass % or about 1 to 5 mass % based on the total solids content of the heat-sensitive recording layer.

The heat-sensitive recording layer is formed on the undercoat layer, for example, by dispersing a leuco dye, a developer, and a stability improver, and if necessary, with or separately from a sensitizer and a stabilizer, using water as a dispersion medium and using at least one of various stirrers or wet pulverizers, such as a ball mill, a co-ball mill, an attritor, or a vertical or horizontal sand mill together with a water-soluble synthetic polymer compound, such as polyacrylamide, polyvinyl pyrrolidone, polyvinyl alcohol, methylcellulose, or a styrene-maleic anhydride copolymer salt, and other additives such as a surfactant to form dispersions; then mixing the dispersions obtained by reducing the average particle diameter so that the average particle diameter is 2 μm or less, and optionally further mixing therewith a binder, an auxiliary agent, and the like to prepare a coating composition for a heat-sensitive recording layer; applying the coating composition for a heat-sensitive recording layer to the undercoat layer and then drying. The coated amount of the heat-sensitive recording layer is not particularly limited and is preferably about 1 to 12 g/m², more preferably about 2 to 10 g/m², even more preferably about 2.5 to 8 g/m², and particularly preferably about 3 to 5.5 g/m², in terms of the coated amount after drying. Note that the heat-sensitive recording layer may be formed as two or more separate layers if necessary, and the composition and coated amount of each layer may be the same or different.

### Protective Layer

The heat-sensitive recording material can comprise a protective layer formed on the heat-sensitive recording layer as necessary. The protective layer preferably contains a pigment and a binder. The protective layer preferably further contains a lubricant, such as polyolefin wax or zinc stearate, for the purpose of preventing the layer from sticking to the thermal head. The protective layer can also contain a UV absorber. When a glossy protective layer is formed, the obtained product can have increased added value.

The pigment contained in the protective layer is not particularly limited. Examples include inorganic pigments, such as amorphous silica, kaolin, clay, light calcium carbonate, heavy calcium carbonate, calcined kaolin, titanium oxide, magnesium carbonate, aluminum hydroxide, colloidal silica, and synthetic layered mica; plastic pigments, such as urea-formalin resin fillers; and the like. The content of the pigment is preferably about 20 to 80 mass %, and more preferably about 30 to 75 mass %, based on the total solids content of the protective layer.

The binder contained in the protective layer is not particularly limited, and an aqueous binder selected from water-soluble binders and water-dispersible binders can be used. The binder can be appropriately selected from those that can be used for the heat-sensitive recording layer. In particular, from the viewpoint of enhancing the binder effect on pigments and the preservation of the recorded portion against plasticizers and solvents such as oil, polyvinyl alcohol or modified polyvinyl alcohol is preferable; in particular, modified polyvinyl alcohols, such as acetoacetyl-modified polyvinyl alcohol, carboxy-modified polyvinyl alcohol, and diacetone-modified polyvinyl alcohol are more preferable. The content of the binder is preferably about 10 to 70 mass %, and more preferably about 20 to 50 mass %, based on the total solids content of the protective layer.

The protective layer is formed on the heat-sensitive recording layer, for example, by mixing a pigment and a binder optionally with an auxiliary agent and the like using water as a dispersion medium to prepare a coating composition for a protective layer, applying the coating composition to the heat-sensitive recording layer, and then drying. The coated amount of the coating composition for a protective layer is not particularly limited and is preferably about 0.3 to 15 g/m², more preferably about 0.3 to 10 g/m², even more preferably about 0.5 to 8 g/m², particularly preferably about 1 to 8 g/m², and further particularly preferably about 1 to 5 g/m², in terms of dry mass. The protective layer may be formed as two or more separate layers if necessary, and the composition and coated amount of each layer may be the same or different.

### Other Layers

In the present invention, the heat-sensitive recording material preferably comprises an adhesive layer on at least one surface of the support. This can increase the added value of the heat-sensitive recording material. For example, adhesive paper, remoistening adhesive paper, or delayed tack paper can be formed as the adhesive layer by subjecting one surface of the support to coating with, for example, an adhesive, such as an adhesive, a remoistening adhesive, or a delayed tack adhesive. Recording paper capable of two-sided recording can also be formed by imparting to the surface of the support opposite to the heat-sensitive recording layer a function as heat transfer paper, ink jet recording paper, carbon-free paper, electrostatic recording paper, or xerography paper. Of course, the heat-sensitive recording material can be formed into a two-side heat-sensitive recording material. A back layer can also be provided to inhibit oil and plasticizer permeation from the back side of the heat-sensitive recording material, or for curl control and antistatic purposes. The heat-sensitive recording material can also be formed into linerless labels that do not require release paper by forming a silicone-containing release layer on the protective layer and applying an adhesive to the one side.

### Heat-Sensitive Recording Material

The heat-sensitive recording material can be produced by forming each layer described above on the support. Any known coating method, such as an air knife method, a blade method, a gravure method, a roll coater method, a spray method, a dip method, a bar method, a curtain method, a slot-die method, a slide die method, and an extrusion method, can be used as the method for forming each layer described above on the support. The individual coating compositions may be applied in such a manner that a first coating composition is applied and dried and then a second coating composition is applied and dried to form one layer after another, or the same coating composition may be applied separately to form two or more layers. Further, simultaneous multilayer coating may also be performed, in which individual coating compositions are applied all at once to form two or more layers simultaneously. In any stage after each layer is formed or after all layers are formed, the layer may be subjected to a smoothing treatment by a known method, such as supercalendering or soft calendering.

### B. Heat-Sensitive Recording Material (B)

In the present invention, the heat-sensitive recording material comprises at least an undercoat layer containing hollow particles, a binder, and an inorganic pigment I, and a heat-sensitive recording layer containing a leuco dye, a developer, and an inorganic pigment II on a support in this order, wherein the heat-sensitive recording layer contains 5-(N-3-methylphenyl-sulfonamide)-N′,N″-bis-(3-methylphenyl)-isophthalic acid diamide as the developer and contains a pigment with an oil absorption of 130 ml/100 g or less as the inorganic pigment II.

### Support

The support for use in this embodiment can be those described in the Support section in A. Heat-sensitive Recording Material (A) above.

### Undercoat Layer

The heat-sensitive recording material of the present invention comprises an undercoat layer between a support and a heat-sensitive recording layer, and the undercoat layer contains hollow particles, a binder, and an inorganic pigment I.

### Hollow Particles

The hollow particles for use can be those described in the Undercoat Layer section in A. Heat-sensitive Recording Material (A) above, and the content of the hollow particles can be set as described in the Undercoat Layer section in A. Heat-sensitive Recording Material (A) above.

### Binder

The binder for use can be those described in the Undercoat Layer section in A. Heat-sensitive Recording Material (A) above, and the content of the binder can be set as described in the Undercoat Layer section in A. Heat-sensitive Recording Material (A) above.

### Inorganic Pigment I

The undercoat layer in the present invention contains an inorganic pigment I. From the viewpoint of increasing recording density and improving alcohol resistance and plasticizer resistance, the undercoat layer preferably contains a pigment with an oil absorption of 130 ml/100 g or less as an inorganic pigment I. The oil absorption of the inorganic pigment I is more preferably 125 ml/100 g or less, and still more preferably 110 ml/100 g or less. The oil absorption of the inorganic pigment I is also preferably 40 ml/100 g or more, and more preferably 80 ml/100 g or more, from the viewpoint of effectively reducing printing problems such as head residue and sticking. The oil absorption is a value determined according to the method of JIS K 5101.

Various inorganic pigments can be used as the inorganic pigment I. Specific examples include inorganic pigments, such as calcium carbonate, such as light calcium carbonate, aluminum hydroxide, clay, such as calcined kaolin and kaolin, and talc. Of these, the inorganic pigment I is preferably at least one member selected from the group consisting of calcium carbonate, aluminum hydroxide, and clay. The content of the inorganic pigment I is preferably 60 mass % or less, and more preferably 50 mass % or less, based on the total solids content of the undercoat layer, from the viewpoint of improving color sensitivity. The content of the inorganic pigment I is also preferably 20 mass % or higher, and more preferably 25 mass % or higher, based on the total solids content of the undercoat layer, from the viewpoint of effectively reducing printing problems such as head residue and sticking.

The undercoat layer is formed on a support, for example, by mixing the hollow particles, the binder, and the inorganic pigment I, and if necessary, auxiliary agents, and the like using water as a medium to prepare a coating composition for an undercoat layer, applying the coating composition to the support, and then drying. The amount of the coating composition for an undercoat layer is not particularly limited, and is preferably about 2 to 20 g/m², and more preferably about 2 to 12 g/m² in terms of dry mass.

### Heat-Sensitive Recording Layer

### Leuco Dye

The heat-sensitive recording layer of the heat-sensitive recording material of the present invention may contain any of various known colorless or pale-colored leuco dyes. The leuco dye for use can be those described in the Heat-sensitive Recording Layer section in A. Heat-sensitive Recording Material (A) above. The content of the leuco dye can be set as described in the Heat-sensitive Recording Layer section in A. Heat-sensitive Recording Material (A) above.

### Developer

In the present invention, the heat-sensitive recording layer contains 5-(N-3-methylphenyl-sulfonamide)-N′,N″-bis-(3-methylphenyl)-isophthalic acid diamide as a developer. This compound combined with the inorganic pigment II can bring about excellent alcohol resistance and plasticizer resistance in the recorded portion, as well as excellent thermal background fogging resistance.

The content of 5-(N-3-methylphenyl-sulfonamide)-N′,N″-bis-(3-methylphenyl)-isophthalic acid diamide is not particularly limited and can be adjusted according to the leuco dye for use. Typically, the content of 5-(N-3-methylphenyl-sulfonamide)-N′,N″-bis-(3-methylphenyl)-isophthalic acid diamide is preferably 0.5 parts by mass or more, more preferably 0.8 parts by mass or more, still more preferably 1 part by mass or more, even more preferably 1.2 parts by mass or more, and particularly preferably 1.5 parts by mass or more, per part by mass of the leuco dye. The content of 5-(N-3-methylphenyl-sulfonamide)-N′,N″-bis-(3-methylphenyl)-isophthalic acid diamide is also preferably 10 parts by mass or less, more preferably 5 parts by mass or less, still more preferably 4 parts by mass or less, and particularly preferably 3.5 parts by mass or less, per part by mass of the leuco dye. A content of 0.5 parts by mass or more can enhance recording performance, and also improve alcohol resistance and plasticizer resistance in the recorded portion, whereas a content of 10 parts by mass or less can effectively decrease background fogging in a high-temperature environment.

The heat-sensitive recording layer may contain another developer (second developer) as long as the effects of the present invention are not impaired. Specific examples of second developers can be those listed as specific examples of developers in the Heat-sensitive Recording Layer section in A. Heat-sensitive Recording Material (A) above.

In the present invention, the second developer is preferably a urea urethane compound represented by the following formula (2), such as 4,4′-bis[(4-methyl-3-phenoxycarbonylaminophenyl)ureid]diphenylsulfone, 4,4′-bis[(2-methyl-5-phenoxycarbonylaminophenyl)ureid]diphenylsulfone, or 4-(2-methyl-3-phenoxycarbonylaminophenyl)ureid-4′-(4-methyl-5-phenoxycarbonylaminophenyl)ureid diphenylsulfone, a crosslinked diphenyl sulfone compound represented by the following formula (3), an N,N′-diarylurea-based compound represented by the following formula (4), a compound represented by the following formula (5), or 4,4′-bis(3-tosylureid)diphenylmethane. This allows the effects of the present invention to be fully brought about.

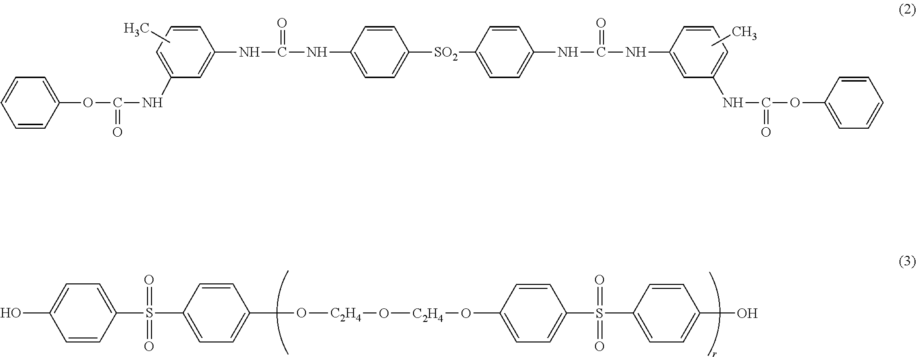

(wherein r represents an integer of 1 to 6)

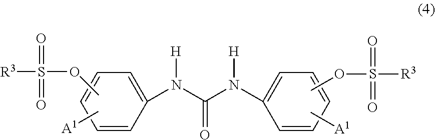

(wherein R³ represents a C₁₋₁₂ alkyl group, a C₇₋₁₂ aralkyl group, or a C₆₋₁₂ aryl group, the aralkyl group and the aryl group may optionally be substituted with a C₁₋₁₂ alkyl group, a C₁₋₁₂ alkoxy group, a C₆₋₁₂ aryl group, or a halogen atom, a plurality of R³s may be the same or different, A¹ represents a hydrogen atom or a C₁₋₄ alkyl group, and a plurality of A¹s may be the same or different).

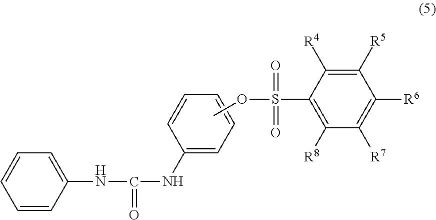

(wherein R⁴ to R⁸ are the same or different and represent a hydrogen atom, a halogen atom, a nitro group, an amino group, an alkyl group, an alkoxy group, an aryloxy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group).

In formula (4) of N,N′-diarylurea-based compound contained as a second developer, the C₁₋₁₂ alkyl group for R³ may be linear, branched, or alicyclic, and preferably a C₁₋₆ alkyl group, and more preferably a C₁₋₃ alkyl group. Examples of C₁₋₁₂ alkyl groups include a methyl group, an ethyl group, an n-propyl group, an i-propyl group, an n-butyl group, an i-butyl group, a t-butyl group, a cyclopentyl group, a hexyl group, a cyclohexyl group, a 2-ethylhexyl group, and a lauryl group. The alkyl group as used here includes the alkyl moiety of a C₁₋₁₂ alkoxy group.

The aralkyl group refers to an aryl alkyl group, and examples of C₇₋₁₂ aralkyl groups include a benzyl group, a 1-phenylethyl group, a 2-phenylethyl group, and a 3-phenylpropyl group.

The aryl group means a monocyclic or polycyclic group formed of one or more 5- or 6-membered aromatic hydrocarbon rings. Examples of C₆₋₁₂ aryl groups include a phenyl group, a 1-naphthyl group, a 2-naphthyl group, and the like. The aryl group as used herein includes the aryl moiety of aralkyl groups.

Examples of halogen atoms include fluorine, chlorine, bromine, and iodine.

In formula (4), the position of substitution of each R³—SO₃— may be the same or different. The substitution position is preferably the 3-position, the 4-position, or the 5-position, and more preferably the 3-position. When the C₇₋₁₂ aralkyl group and the C₆₋₁₂ aryl group represented by R₂ are substituted, the number of substituents is not particularly limited, and is for example, 1 to 4.

The C₁₋₄ alkyl group represented by Au may be linear or branched. Examples include a methyl group, an ethyl group, a propyl group, an isopropyl group, a butyl group, an isobutyl group, a sec-butyl group, a t-butyl group, and the like.

The substitution position of each A₁ may be the same or different. The substitution position is preferably the 3-position, the 4-position, or the 5-position.

The N,N′-diarylurea-based compound represented by formula (4) is not particularly limited, and is preferably at least one member selected from the group consisting of N,N′-di-[3-(p-toluenesulfonyloxy)phenyl]urea, N,N′-di-[3-(o-toluenesulfonyloxy)phenyl]urea, N,N′-di-[3-(benzenesulfonyloxy)phenyl]urea, N,N′-di-[3-(mesitylenesulfonyloxy)phenyl]urea, N,N′-di-[3-(4-ethylbenzenesulfonyloxy)phenyl]urea, N,N′-di-[3-(2-naphthalenesulfonyloxy)phenyl]urea, N,N′-di-[3-(p-methoxybenzenesulfonyloxy)phenyl]urea, N,N′-di-[3-(benzylsulfonyloxy)phenyl]urea, N,N′-di-[3-(ethanesulfonyloxy)phenyl]urea, N,N′-di-[3-(p-toluenesulfonyloxy)-4-methyl-phenyl]urea, N,N′-di-[4-(p-toluenesulfonyloxy)phenyl]urea, N,N′-di-[4-(benzenesulfonyloxy)phenyl]urea, N,N′-di-[4-(ethanesulfonyloxy)phenyl]urea, and N,N′-di-[2-(p-toluenesulfonyloxy)]phenylurea. Of these, N,N′-di-[3-(p-toluenesulfonyloxy)phenyl]urea is preferred.

The halogen atom represented by R⁴ to R⁸ may be a fluorine atom, a chlorine atom, or a bromine atom, with a fluorine atom and a chlorine atom being preferred.

The alkyl group may be linear, branched, or cyclic, and is preferably a linear or branched alkyl group, and more preferably a linear alkyl group. Typically, the alkyl group is a C₁₋₁₂ alkyl group, preferably a C₁₋₈ alkyl group, more preferably a C₁₋₆ alkyl group, and still more preferably a C₁₋₄ alkyl group.

The alkoxy group may be linear, branched, or cyclic, and is preferably a linear or branched alkoxy group, and more preferably a linear alkoxy group. Typically, the alkoxy group is a C₁₋₁₂ alkoxy group, preferably a C₂₋₈ alkoxy group, more preferably a C₂₋₆ alkoxy group, and still more preferably a C₂₋₄ alkoxy group.

The alkylcarbonyloxy group may be linear, branched, or cyclic, and is preferably a linear or branched alkylcarbonyloxy group, and more preferably a linear alkylcarbonyloxy group. The alkylcarbonyloxy group is also preferably a C₁₋₁₀ alkylcarbonyloxy group.

The alkylcarbonylamino group may be linear, branched, or cyclic, and is preferably a linear or branched alkylcarbonylamino group, and more preferably a linear alkylcarbonylamino group. The alkylcarbonylamino group is also preferably a C₁₋₁₀ alkylcarbonylamino group.

The alkylsulfonylamino group may be linear, branched, or cyclic, and is preferably a linear or branched alkylsulfonylamino group, and more preferably a linear alkylsulfonylamino group. The alkylsulfonylamino group is also preferably a C₁₋₁₀ alkylsulfonylamino group.

The aryl group means a monocyclic or polycyclic group formed of one or more 5- or 6-membered aromatic hydrocarbon rings. Examples of aryl groups include a phenyl group, a naphthyl group, and a biphenyl group.

The aryloxy group is preferably a C₆₋₁₂ aryloxy group. The arylcarbonyloxy group is preferably a C₆₋₁₂ arylcarbonyloxy group. The arylcarbonylamino group is preferably a C₆₋₁₂ arylcarbonylamino group. The arylsulfonylamino group is preferably a C₆₋₁₂ arylsulfonylamino group.

The monoalkylamino group may be linear, branched, or cyclic, and is preferably a linear or branched monoalkylamino group, and more preferably a linear monoalkylamino group. A monoalkylamino group whose alkyl group has 1 to 10 carbon atoms is also preferable.

The dialkylamino group may be linear, branched, or cyclic, and is preferably a linear or branched dialkylamino group, and more preferably a linear dialkylamino group. A dialkylamino group whose alkyl group has 1 to 10 carbon atoms is also preferable.

The arylamino group may be a monoarylamino group or diarylamino group, and is preferably a C₆₋₁₂ monoarylamino group.

Specific examples of compounds represented by formula (5) include those wherein R⁴ to R⁸ are an alkyl group or a hydrogen atom, preferably R⁴ to R⁸ are a C₁₋₈ linear alkyl group or a hydrogen atom, more preferably R⁴ to R⁸ are a C₁₋₄ linear alkyl group or a hydrogen atom, and still more preferably R⁴ to R⁸ are a methyl group or a hydrogen atom.

Specific examples of other compounds represented by formula (5) include those wherein R⁴, R⁵, R⁷, and R⁸ are a hydrogen atom and R⁶ is a hydrogen atom, a halogen atom, a nitro group, an amino group, an alkyl group, an alkoxy group, an aryloxy group, an alkylcarbonyloxy group, an alkylcarbonylamino group, an arylcarbonylamino group, an alkylsulfonylamino group, an arylsulfonylamino group, a monoalkylamino group, a dialkylamino group, or an arylamino group (preferably a hydrogen atom or an alkyl group, more preferably a hydrogen atom or a C₁₋₈ alkyl group, still more preferably a hydrogen atom or a C₁₋₄ alkyl group, and particularly preferably a methyl group).

The position of the substituent bound to one benzene ring in the diphenylurea structure in formula (5) may be the ortho-position, the meta-position, or the para-position, preferably the ortho-position or the meta-position, and more preferably the meta-position with respect to the aminocarbonyl group on the benzene ring.

The compound represented by formula (5) is not particularly limited, and is preferably at least one member selected from the group consisting 3-[(phenylcarbamoyl)amino]phenyl-4-methylbenzenesulfonate, 2-[(phenylcarbamoyl)amino]phenyl-4-methylbenzenesulfonate, and 4-[(phenylcarbamoyl)amino]phenyl-4-methylbenzenesulfonate. Of these, 3-[(phenylcarbamoyl)amino]phenyl-4-methylbenzenesulfonate is preferable.

The content of the second developer is not particularly limited, and is preferably 0.2 to 3 parts by mass, per part by mass of the leuco dye. The content of the second developer is also preferably about 0.2 to 0.5 parts by mass, per part by mass of 5-(N-3-methylphenyl-sulfonamide)-N′,N″-bis-(3-methylphenyl)-isophthalic acid diamide used as the first developer.

### Inorganic Pigment II

The heat-sensitive recording layer of the present invention contains a pigment with an oil absorption of 130 ml/100 g or less as an inorganic pigment II. The oil absorption of the inorganic pigment II is preferably 125 ml/100 g or less, more preferably 100 ml/100 g or less, and most preferably 65 ml/100 g or less. Use of the inorganic pigment II can significantly increase alcohol resistance and plasticizer resistance. From the viewpoint of effectively reducing printing problems such as head residue and sticking, the oil absorption of the inorganic pigment II is preferably 30 ml/100 g or more. The heat-sensitive recording layer of the present invention may contain a pigment with an oil absorption of more than 130 ml/100 g as long as the effects of the present invention are not impaired. The content of the pigment with an oil absorption of more than 130 ml/100 g is preferably 0.5 parts by mass or less, more preferably 0.3 parts by mass or less, and even more preferably 0.1 parts by mass or less, per part by mass of the pigment with an oil absorption of 130 ml/100 g or less. It is particularly preferred that the heat-sensitive recording layer does not contain a pigment with an oil absorption of more than 130 ml/100 g. The oil absorption is a value determined according to the method of JIS K 5101.

Various inorganic pigments can be used as the inorganic pigment II. Specific examples include inorganic pigments, such as calcium carbonate, such as light calcium carbonate, aluminum hydroxide, clay, such as calcined kaolin and kaolin, and talc. Of these, the inorganic pigment II is preferably at least one member selected from the group consisting of calcium carbonate, aluminum hydroxide, and clay. The type of the inorganic pigment II may be different from or the same as the inorganic pigment I. The content of the inorganic pigment II can be selected from a wide range, and is preferably 10 to 50 mass %, more preferably 10 to 40 mass %, and even more preferably 15 to 35 mass %, based on the total solids content of the heat-sensitive recording layer.

In the present invention, the heat-sensitive recording layer may further contain a stabilizer mainly in order to further enhance the preservation of the developed color image. As such a stabilizer, it is possible to use, for example, at least one member selected from the group consisting of phenol compounds, such as 1,1,3-tris(2-methyl-4-hydroxy-5-cyclohexylphenyl)butane, 1,1,3-tris(2-methyl-4-hydroxy-5-tert-butylphenyl)butane, 1,1-bis(2-methyl-4-hydroxy-5-tert-butylphenyl)butane, 4,4′-[1,4-phenylenebis(1-methylethylidene)]bisphenol, and 4,4′-[1,3-phenylenebis(1-methylethylidene)]bisphenol; epoxy compounds, such as 4-benzyloxyphenyl-4′-(2-methyl-2,3-epoxypropyloxy)phenylsulfone, 4-(2-methyl-1,2-epoxyethyl)diphenylsulfone, and 4-(2-ethyl-1,2-epoxyethyl)diphenylsulfone; and isocyanuric acid compounds, such as 1,3,5-tris(2,6-dimethylbenzyl-3-hydroxy-4-tert-butyl)isocyanuric acid. Usable stabilizers are, of course, not limited to these compounds, and two or more of such compounds can be used in combination as necessary.

When the stabilizer is used, its amount may be an effective amount for improving image preservation. The stabilizer is typically preferably used in an amount of about 1 to 25 mass %, and more preferably about 5 to 20 mass %, based on the total solids content of the heat-sensitive recording layer.

In the present invention, the heat-sensitive recording layer may further contain a sensitizer. This can enhance recording sensitivity. The sensitizer for use can be those described in the Heat-sensitive Recording Layer section in A. Heat-sensitive Recording Material (A) above, and the content of the sensitizer can be set as described in the Heat-sensitive Recording Layer section in A. Heat-sensitive Recording Material (A) above.

As other components that constitute the heat-sensitive recording layer, a binder can be used. Further, if necessary, auxiliary agents, such as crosslinking agents, waxes, metal soaps, water resistance improving agents, dispersants, colored dyes, and fluorescent dyes can be used. The binder and crosslinking agent for use can be those described in the Heat-sensitive Recording Layer section in A. Heat-sensitive Recording Material (A) above, and the content of the binder and crosslinking agent for use can be set as described in the Heat-sensitive Recording Layer section in A. Heat-sensitive Recording Material (A) above.

The heat-sensitive recording layer is formed on the undercoat layer, for example, by dispersing a leuco dye and a developer, and if necessary, with or separately from a sensitizer and a stabilizer, using water as a dispersion medium and using at least one of various stirrers or wet pulverizers, such as a ball mill, a co-ball mill, an attritor, or a vertical or horizontal sand mill together with a water-soluble synthetic polymer compound, such as polyacrylamide, polyvinyl pyrrolidone, polyvinyl alcohol, methylcellulose, or a styrene-maleic anhydride copolymer salt, and other additives such as a surfactant to form dispersions, reducing the average particle diameter of the dispersions so that the average particle diameter is 2 μm or less, then mixing the dispersions with an inorganic pigment II and optionally further mixing therewith a binder, an auxiliary agent, and the like to prepare a coating composition for a heat-sensitive recording layer; applying the coating composition for a heat-sensitive recording layer to the undercoat layer and then drying. The coated amount of the heat-sensitive recording layer is not particularly limited and is preferably about 1 to 12 g/m², more preferably about 2 to 10 g/m², even more preferably about 2.5 to 8 g/m², and particularly preferably about 3 to 5.5 g/m², in terms of the coated amount after drying. Note that the heat-sensitive recording layer may be formed as two or more separate layers if necessary, and the composition and coated amount of each layer may be the same or different.

### Protective Layer

The heat-sensitive recording material can comprise a protective layer formed on the heat-sensitive recording layer as necessary. The protective layer for use can be those described in the Protective Layer section in A. Heat-sensitive Recording Material (A) above.

### Other Layers

In this embodiment, the heat-sensitive recording material can be further processed to impart higher functionality to it for enhanced added value. Other layers for use can be those described in the Other Layers section in A. Heat-sensitive Recording Material (A) above.

### Heat-Sensitive Recording Material

The heat-sensitive recording material can be produced by forming the individual layers described above on a support. The method for forming the layers can be the method described in the Heat-sensitive Recording Material section in A.

Heat-sensitive Recording Material (A) above.

### EXAMPLES

The present invention is described in more detail with reference to Examples. However, the present invention is not limited to these Examples. In the Examples, “parts” and “%” represent “parts by mass” and “mass %” unless otherwise specified. The particle diameters, such as average particle diameters and maximum particle diameters, were measured with a SALD2200 laser diffraction particle diameter distribution analyzer (produced by Shimadzu Corporation). “Average particle diameter” as used herein refers to a median diameter (D50).

The hollow particles used in the Examples and Comparative Example are as follows.
Hollow particles A: average particle diameter (D50): 5.0 μm; maximum particle diameter (D100): 13.5 μm; D100/D50=2.7; hollow ratio: 90%, proportion of particles having a particle diameter of 2 μm or less: 0.2 volume %; solids content: 15.0%; foamed type.
Hollow particles B: average particle diameter (D50): 11 μm; maximum particle diameter (D100): 23 μm; D100/D50=2.1; hollow ratio: 93%; proportion of particles having a particle diameter of 2 μm or less: 0 volume %; solids content: 15.0%; foamed type.
Hollow particles C: trade name: Ropaque SN-1055, produced by The Dow Chemical Company; average particle diameter (D50): 1.0 μm; maximum particle diameter (D100): 1.8 μm; D100/D50=1.8; hollow ratio: 55%; proportion of particles having a particle diameter of 2 μm or less: 100 volume %; solids content: 26.5%; non-foamed type. The average particle diameters (D50) and maximum particle diameters (D100) of these hollow particles were measured using a SALD2200 laser diffraction particle diameter distribution analyzer (produced by Shimadzu Corporation) at a refractive index of 1.70-0.01i.

The latexes used in the Examples and Comparative Example are as follows.
Latex A: styrene-butadiene copolymer latex (Tg: −35° C.; particle diameter: 300 nm; solids content: 48%)
Latex B: styrene-butadiene copolymer latex (Tg: −10° C.; particle diameter: 190 nm; solids content: 48%)
Latex C: styrene-butadiene copolymer latex (trade name: L-1571, produced by Asahi Kasei Corporation; Tg: −3° C.; particle diameter: 190 nm; solids content: 48%)

### A. Heat-Sensitive Recording Material (A)

### Example A1

### (1) Preparation of Coating Liquid for Undercoat Layer

A coating liquid for an undercoat layer was prepared by mixing and stirring a composition containing 100 parts of hollow particles A, 38 parts of calcined kaolin (trade name: Ansilex 93, produced by BASF; oil absorption: 105 ml/100 g), 79.2 parts of latex A, 32 parts of a 25% aqueous solution of oxidized starch, 1.1 parts of carboxyrethylcellulose (trade name: Cellogen AG gum, produced by DKS Co., Ltd.), and 100 parts of water.

### (2) Preparation of Leuco Dye Dispersion (Liquid A1)

40 parts of 3-di(n-butyl)amino-6-methyl-7-anilinofluoran, 40 parts of a 10% aqueous solution of polyvinyl alcohol (degree of polymerization: 500; degree of saponification: 88%), and 20 parts of water were mixed. The resulting mixture was pulverized with a sand mill (produced by Imex Co., Ltd., a sand grinder) to an average particle diameter of 0.5 μm, thus obtaining a leuco dye dispersion (liquid A1).

### (3-1) Preparation of Developer Dispersion (Liquid B1-1)

40 parts of 4-hydroxy-4′-isopropoxy diphenyl sulfone, 40 parts of a 10% aqueous solution of polyvinyl alcohol (degree of polymerization: 500; degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B1-1).

### (4-1) Preparation of Stability Improver Dispersion (Liquid C1-1)

40 parts of 5-(N-3-methylphenyl-sulfonamide)-N′,N″-bis-(3-methylphenyl)-isophthalic acid diamide, 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a stability improver dispersion (liquid C1-1).

### (5) Preparation of Sensitizer Dispersion (Liquid D1)

40 parts of 1,2-di(3-methylphenoxy)ethane (trade name: KS-232, produced by Sankosha Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a sensitizer dispersion (liquid D1).

### (6) Preparation of Coating Liquid for Heat-Sensitive Recording Layer

A coating liquid for a heat-sensitive recording layer was prepared by mixing and stirring a composition containing 31.8 parts of liquid A1, 63.6 parts of liquid B1-1, 15.9 parts of liquid C1-1, 22.7 parts of liquid D1, 46.7 parts of a 15% aqueous solution of completely saponified polyvinyl alcohol (trade name: PVA110, saponification: 99 mol %, average degree of polymerization: 1000, produced by Kuraray Co., Ltd.), 20.8 parts of latex C, 18 parts of aluminum hydroxide (trade name: KH-101, produced by KC Corporation), 5 parts of adipic acid dihydrazide (produced by Otsuka Chemical Co., Ltd.), and 200 parts of water.

### (7) Preparation of Coating Liquid for Protective Layer

A coating liquid for a protective layer was prepared by mixing and stirring a composition containing 308 parts of a 12% aqueous solution of diacetone-modified polyvinyl alcohol (trade name: DF-10, produced by Japan Vam & Poval Co., Ltd.), 60 parts of kaolin (trade name: Hydragloss 90, produced by KaMin LLC), 5.6 parts of zinc stearate (trade name: Hidorin Z-8, produced by Chukyo Yushi Co., Ltd., solid concentration: 36%), and 150 parts of water.

### (8) Preparation of Heat-Sensitive Recording Material

The coating liquid for an undercoat layer, the coating liquid for a heat-sensitive recording layer, and the coating liquid for a protective layer were applied in amounts after drying of 4.5 g/m², 4.0 g/m², and 2.5 g/m², respectively, to one surface of high-quality paper having a basis weight of 60 g/m², and dried to form an undercoat layer, a heat-sensitive recording layer, and a protective layer in this order. The obtained product was then super-calendered to smooth the surface, thus obtaining a heat-sensitive recording material.

### Example A2

A heat-sensitive recording material was obtained in the same manner as in Example A1, except that in the preparation of the coating liquid for a heat-sensitive recording layer of Example A1, the amount of liquid C1-1 was changed to 6.8 parts from 15.9 parts.

### Example A3

A heat-sensitive recording material was obtained in the same manner as in Example A1, except that in the preparation of the coating liquid for a heat-sensitive recording layer of Example A1, the amount of liquid B1-1 was changed to 39.8 parts from 63.6 parts, and the amount of liquid C1-1 was changed to 39.8 parts from 15.9 parts.

### Example A4

A heat-sensitive recording material was obtained in the same manner as in Example A1, except that in the preparation of the coating liquid for a heat-sensitive recording layer of Example A1, the amount of liquid B1-1 was changed to 31.8 parts from 63.6 parts, and the amount of liquid C1-1 was changed to 47.7 parts from 15.9 parts.

### Example A5

A heat-sensitive recording material was obtained in the same manner as in Example A1, except that in the preparation of the coating liquid for a heat-sensitive recording layer of Example A1, the amount of liquid B1-1 was changed to 15.9 parts from 63.6 parts, and the amount of liquid C1-1 was changed to 63.6 parts from 15.9 parts.

### Example A6

### (3-2) Preparation of Developer Dispersion (Liquid B1-2)

40 parts of 2,4′-dihydroxydiphenyl sulfone (trade name: 2,4′-BPS, produced by Nicca Chemical Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B1-2).

A heat-sensitive recording material was obtained in the same manner as in Example A1, except that in the preparation of the coating liquid for a heat-sensitive recording layer of Example A1, the developer dispersion was liquid B1-2 instead of liquid B1-1.

### Example A7

### (3-3) Preparation of Developer Dispersion (Liquid B1-3)

40 parts of 4,4′-dihydroxydiphenyl sulfone (trade name: 4,4′-BPS, produced by Nicca Chemical Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B1-3).

A heat-sensitive recording material was obtained in the same manner as in Example A1, except that in the preparation of the coating liquid for a heat-sensitive recording layer of Example A1, the developer dispersion was liquid B1-3 instead of liquid B1-1.

### Example A8

### (3-4) Preparation of Developer Dispersion (Liquid B1-4)

40 parts of bis(3-allyl-4-hydroxyphenyl) sulfone (trade name: TG-SH, produced by Nippon Kayaku Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B1-4).

A heat-sensitive recording material was obtained in the same manner as in Example A1, except that in the preparation of the coating liquid for a heat-sensitive recording layer of Example A1, the developer dispersion was liquid B1-4 instead of liquid B1-1.

### Example A9

### (3-5) Preparation of Developer Dispersion (Liquid B1-5)

40 parts of 4-hydroxyphenyl(4′-n-propoxyphenyl) sulfone (trade name: Tomirac KN, produced by Mitsubishi Chemical Corporation), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B1-5).

A heat-sensitive recording material was obtained in the same manner as in Example A1, except that in the preparation of the coating liquid for a heat-sensitive recording layer of Example A1, the developer dispersion was liquid B1-5 instead of liquid B1-1.

### Example A10

### (3-6) Preparation of Developer Dispersion (Liquid B1-6)

40 parts of 4-hydroxy-4′-benzyloxydiphenyl sulfone (trade name: BPS-MBE, produced by Nicca Chemical Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B1-6).

A heat-sensitive recording material was obtained in the same manner as in Example A1, except that in the preparation of the coating liquid for a heat-sensitive recording layer of Example A1, the developer dispersion was liquid B1-6 instead of liquid B1-1.

### Example A11

### (3-7) Preparation of Developer Dispersion (Liquid B1-7)

40 parts of 4-allyloxy-4′-hydroxydiphenyl sulfone (trade name: BPS-MAE, produced by Nicca Chemical Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B1-7).

A heat-sensitive recording material was obtained in the same manner as in Example A1, except that in the preparation of the coating liquid for a heat-sensitive recording layer of Example A1, the developer dispersion was liquid B1-7 instead of liquid B1-1.

### Example A12

### (3-8) Preparation of Developer Dispersion (Liquid B1-8)

40 parts of N-p-tolylsulfonyl-N′-3-(p-tolylsulfonyloxy)phenylurea (trade name: PF-201, produced by Solenis), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B1-8).

A heat-sensitive recording material was obtained in the same manner as in Example A1, except that in the preparation of the coating liquid for a heat-sensitive recording layer of Example A1, the developer dispersion was liquid B1-8 instead of liquid B1-1.

### Example A13

### (3-9) Preparation of Developer Dispersion (Liquid B1-9)

40 parts of N-[2-(3-phenylureid)phenyl]benzenesulfonamide (trade name: NKK-1304, produced by Nippon Soda Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B1-9).

A heat-sensitive recording material was obtained in the same manner as in Example A1, except that in the preparation of the coating liquid for a heat-sensitive recording layer of Example A1, the developer dispersion was liquid B1-9 instead of liquid B1-1.

### Example A14

A heat-sensitive recording material was obtained in the same manner as in Example A13, except that in the preparation of the coating liquid for an undercoat layer of Example A13, the amount of the hollow particles A was changed to 46.7 parts from 100 parts, the amount of the calcined kaolin was changed to 46 parts from 38 parts, and the amount of water was changed to 145 parts from 100 parts.

### Example A15

A heat-sensitive recording material was obtained in the same manner as in Example A13, except that in the preparation of the coating liquid for an undercoat layer of Example A13, latex B was used instead of latex A.

### Example A16

A heat-sensitive recording material was obtained in the same manner as in Example A13, except that in the preparation of the coating liquid for an undercoat layer of Example A13, latex C was used instead of latex A.

### Example A17

A heat-sensitive recording material was obtained in the same manner as in Example A13, except that in the preparation of the coating liquid for an undercoat layer of Example A13, hollow particles B were used instead of hollow particles A.

### Example A18

A heat-sensitive recording material was obtained in the same manner as in Example A13, except that in the preparation of the coating liquid for an undercoat layer of Example A13, 56.6 parts of hollow particles C were used instead of 100 parts of hollow particles A, and the amount of water was changed to 175 parts from 100 parts.

### Comparative Example A1

A heat-sensitive recording material was obtained in the same manner as in Example A1, except that in the preparation of the coating liquid for a heat-sensitive recording layer of Example A1, the amount of liquid B1-1 was changed to 79.5 parts from 63.6 parts, and the amount of liquid C1-1 was changed to 0 parts from 15.9 parts.

### Comparative Example A2

### (4-2) Preparation of Stability Improver Dispersion (Liquid C₁₋₂)

40 parts of a crosslinked diphenyl sulfone compound represented by formula (3) (trade name: D-90, produced by Nippon Soda Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a stability improver dispersion (liquid C1-2).

A heat-sensitive recording material was obtained in the same manner as in Example A1, except that in the preparation of the coating liquid for a heat-sensitive recording layer of Example A1, the stability improver dispersion was liquid C1-2 instead of liquid C1-1.

### Comparative Example A3

### (4-3) Preparation of Stability Improver Dispersion (Liquid C₁₋₃)

40 parts of a 4,4′-bis[(4-methyl-3-phenoxycarbonylaminophenyl)ureid]diphenylsulfone represented by formula (2) (trade name: UU, produced by Chemipro Kasei Kaisha, Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a stability improver dispersion (liquid C1-3).

A heat-sensitive recording material was obtained in the same manner as in Example A1, except that in the preparation of the coating liquid for a heat-sensitive recording layer of Example A1, the stability improver dispersion was liquid C1-3 instead of liquid C1-1.

### Comparative Example A4

A heat-sensitive recording material was obtained in the same manner as in Example A11, except that in the preparation of the coating liquid for a heat-sensitive recording layer of Example A11, the stability improver dispersion was liquid C1-2 instead of liquid C1-1.

### Comparative Example A5

A heat-sensitive recording material was obtained in the same manner as in Example A11, except that in the preparation of the coating liquid for a heat-sensitive recording layer of Example A11, the stability improver dispersion was liquid C1-3 instead of liquid C1-1.

### Comparative Example A6

A heat-sensitive recording material was obtained in the same manner as in Example A12, except that in the preparation of the coating liquid for a heat-sensitive recording layer of Example A12, the amount of liquid B1-8 was changed to 79.5 parts from 63.6 parts, and the amount of liquid C1-1 was changed to 0 parts from 15.9 parts.

### Comparative Example A7

A heat-sensitive recording material was obtained in the same manner as in Example A12, except that in the preparation of the coating liquid for a heat-sensitive recording layer of Example A12, the stability improver dispersion was liquid C1-2 instead of liquid C1-1.

### Comparative Example A8

A heat-sensitive recording material was obtained in the same manner as in Example A12, except that in the preparation of the coating liquid for a heat-sensitive recording layer of Example A12, the stability improver dispersion was liquid C1-3 instead of liquid C1-1.

### Comparative Example A9

A heat-sensitive recording material was obtained in the same manner as in Example A13, except that in the preparation of the coating liquid for a heat-sensitive recording layer of Example A13, the amount of liquid B1-9 was changed to 79.5 parts from 63.6 parts, and the amount of liquid C1-1 was changed to 0 parts from 15.9 parts.

### Comparative Example A10

A heat-sensitive recording material was obtained in the same manner as in Example A13, except that in the preparation of the coating liquid for a heat-sensitive recording layer of Example A13, the stability improver dispersion was liquid C1-2 instead of liquid C1-1.

### Comparative Example A11

A heat-sensitive recording material was obtained in the same manner as in Example 13, except that in the preparation of the coating liquid for a heat-sensitive recording layer of Example A13, the stability improver dispersion was liquid C1-3 instead of liquid C1-1.

The Examples and Comparative Examples were evaluated according to the following method. Table 1 shows the results.

### Recording Density

An image was recorded on each heat-sensitive recording material at applied energies of 0.17 mJ/dot (medium energy color density) and 0.25 mJ/dot (high energy color density) using a thermal recording tester (trade name: TH-PMD, produced by Ohkura Electric Co., Ltd.). The reflection density of the obtained recorded portion was measured with a spectrodensitometer (X-Rite 504, produced by X-Rite). If preservation is equivalent, a higher density is preferable; the following criteria were used as a guide for evaluation.

### Medium Energy Color Density

1.00 or higher: compatible with high-speed printing, very good
0.80 or higher and lower than 1.00: no practical problem
Lower than 0.80: low sensitivity with many defects such as white spots, problematic in practical use

### High Energy Color Density

1.40 or higher: very good
1.20 or higher and lower than 1.40: no practical problem
Lower than 1.20: low printing density, undesirable for practical use

### Water Resistance

A sample of each heat-sensitive recording material that had been subjected to color development using a label printer (trade name: L-2000, produced by Ishida Co., Ltd.) was immersed in water at 20° C. for 24 hours. The reflection density of the recorded portion was measured with a spectrodensitometer (X-Rite 504, produced by X-Rite) before and after the immersion treatment. Further, the remaining percentage of the recorded portion was determined according to the following equation. The remaining percentage was evaluated according to the following criteria.

$$Remaining perentage ( \% ) = \text{} ( recording density after treatment / recording density before treatment ) \times 100$$

A remaining percentage of 80% or higher: very good
A remaining percentage of 60% or higher and lower than 80%: no practical problem
A remaining percentage of lower than 60%: the recording density after treatment is significantly reduced, which is problematic in practical use

### Water Plasticizer Resistance

A wrap film (trade name: Hi-S Soft, produced by Nippon Carbide Industries Co., Inc.) was wound around a polycarbonate pipe (diameter: 40 mm) three times, and a sample prepared by immersing a heat-sensitive recording material that had been subjected to color development using a label printer (trade name: L-2000, produced by Ishida Co., Ltd.) in water for 5 seconds was placed on the film. The wrap film was further wound around the sample three times, and the sample was allowed to stand at 40° C. for 24 hours. Before and after this treatment, the reflection density of the recorded portion was measured with a spectrodensitometer (X-Rite 504, produced by X-Rite). Further, the remaining percentage of the recorded portion was determined according to the following equation. The remaining percentage was evaluated according to the following criteria.

$$Remaining percentage ( \% ) = \text{} ( recording density after treatment / recording density before treatment ) \times 100$$

A remaining percentage of 80% or higher: very good
A remaining percentage of 60% or higher and lower than 80%: no practical problem
A remaining percentage of lower than 60%: the recording density after treatment is significantly reduced, which is problematic in practical use

### Alcohol Resistance

A sample of each heat-sensitive recording material that had been subjected to color development using a label printer (trade name: L-2000, produced by Ishida Co., Ltd.) was immersed in a 75 volume % aqueous solution of ethanol for 10 minutes. Before and after this treatment, the reflection density of the background portion and the recorded portion was measured with a spectrodensitometer (X-Rite 504, produced by X-Rite). Further, the remaining percentage of the recorded portion was determined according to the following equation. The background portion density and the remaining percentage after treatment were evaluated according to the following criteria.

$$Remaining perentage ( \% ) = \text{} ( recording density after treatment / recording density before treatment ) \times 100$$

A background portion density of 0.10 or lower: very good
A background portion density of higher than 0.10 and 0.20 or lower: fogging is somewhat observed, but no practical problem
A background portion density of higher than 0.20: significant fogging, which is problematic in practical use
A remaining percentage of 80% or higher: very good
A remaining percentage of 60% or higher and lower than 80%: no practical problem
A remaining percentage of lower than 60%: the recording density after treatment is significantly reduced, which is problematic in practical use

TABLE 1

| | | | Preservation Test | | | | |
|---|---|---|---|---|---|---|---|
| | | | | | | Alcohol Resistance | |
| | | | Recording | Water | Water Plasticizer | | Recorded |
| | Recording Density | | Density | Resistance | Resistance | Background | Portion |
| | 0.17 | 0.25 | before | Remaining | Remaining | Portion | Remaining |
| | (mJ/dot) | (mJ/dot) | Treatment | Percentage (%) | Percentage (%) | Density | Percentage (%) |
| Example A1 | 1.10 | 1.50 | 1.45 | 73 | 67 | 0.06 | 66 |
| Example A2 | 1.12 | 1.48 | 1.48 | 67 | 62 | 0.06 | 62 |
| Example A3 | 1.01 | 1.45 | 1.48 | 81 | 78 | 0.06 | 72 |
| Example A4 | 0.90 | 1.38 | 1.48 | 93 | 91 | 0.06 | 81 |
| Example A5 | 0.74 | 1.18 | 1.16 | 95 | 94 | 0.06 | 93 |
| Example A6 | 0.82 | 1.47 | 1.44 | 65 | 63 | 0.06 | 64 |
| Example A7 | 0.84 | 1.48 | 1.44 | 66 | 62 | 0.06 | 63 |
| Example A8 | 1.15 | 1.52 | 1.50 | 69 | 67 | 0.06 | 67 |
| Example A9 | 0.95 | 1.46 | 1.45 | 69 | 67 | 0.06 | 68 |
| Example A10 | 1.00 | 1.41 | 1.41 | 65 | 68 | 0.06 | 66 |
| Example A11 | 1.06 | 1.46 | 1.44 | 66 | 71 | 0.06 | 66 |
| Example A12 | 0.91 | 1.39 | 1.36 | 94 | 96 | 0.07 | 87 |
| Example A13 | 0.90 | 1.38 | 1.33 | 92 | 94 | 0.07 | 84 |
| Example A14 | 0.82 | 1.37 | 1.33 | 92 | 95 | 0.07 | 84 |
| Example A15 | 0.86 | 1.37 | 1.33 | 92 | 95 | 0.07 | 82 |
| Example A16 | 0.83 | 1.36 | 1.34 | 91 | 94 | 0.07 | 82 |
| Example A17 | 0.83 | 1.33 | 1.30 | 92 | 95 | 0.07 | 83 |
| Example A18 | 0.60 | 1.24 | 1.26 | 91 | 92 | 0.06 | 75 |
| Comparative | 1.15 | 1.51 | 1.47 | 45 | 35 | 0.06 | 32 |
| Example A1 | | | | | | | |
| Comparative | 1.13 | 1.48 | 1.44 | 51 | 37 | 0.06 | 35 |
| Example A2 | | | | | | | |
| Comparative | 1.12 | 1.48 | 1.44 | 62 | 48 | 0.23 | 55 |
| Example A3 | | | | | | | |
| Comparative | 1.05 | 1.43 | 1.38 | 45 | 35 | 0.06 | 34 |
| Example A4 | | | | | | | |
| Comparative | 1.04 | 1.41 | 1.38 | 51 | 42 | 0.24 | 54 |
| Example A5 | | | | | | | |
| Comparative | 0.92 | 1.39 | 1.32 | 51 | 50 | 0.07 | 55 |
| Example A6 | | | | | | | |
| Comparative | 0.87 | 1.35 | 1.31 | 50 | 52 | 0.07 | 56 |
| Example A7 | | | | | | | |
| Comparative | 0.87 | 1.35 | 1.31 | 65 | 63 | 0.24 | 68 |
| Example A8 | | | | | | | |
| Comparative | 0.89 | 1.36 | 1.32 | 54 | 57 | 0.07 | 45 |
| Example A9 | | | | | | | |
| Comparative | 0.88 | 1.35 | 1.31 | 55 | 57 | 0.07 | 46 |
| Example A10 | | | | | | | |
| Comparative | 0.89 | 1.36 | 1.31 | 68 | 68 | 0.25 | 55 |
| Example A11 | | | | | | | |

### B. Heat-Sensitive Recording Material (B)

### Example B1

### (1) Preparation of Coating Liquid for Undercoat Layer

100 parts of hollow particles A, 38 parts of calcined kaolin (trade name: Ansilex 93, produced by BASF A.G., oil absorption: 105 ml/100 g), 79.2 parts of latex A, 32 parts of a 25% solution of oxidized starch, 1.1 parts of carboxymethylcellulose (trade name: Cellogen AG Gum, produced by DKS Co., Ltd.), and 100 parts of water were mixed and stirred, thus obtaining a coating liquid for an undercoat layer.

### (2) Preparation of Leuco Dye Dispersion (Liquid A2)

40 parts of 3-di-(n-butyl)amino-6-methyl-7-anilinofluorane, 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 0.5 μm, thus obtaining a leuco dye dispersion (liquid A2).

### (3) Preparation of Developer Dispersion (Liquid B2)

40 parts of 5-(N-3-methylphenyl-sulfonamide)-N′,N″-bis-(3-methylphenyl)-isophthalic acid diamide, 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid B2).

### (4) Preparation of Sensitizer Dispersion (Liquid C₂)

40 parts of 1,2-di(3-methylphenoxy)ethane (trade name: KS-232, produced by Sankosha Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a sensitizer dispersion (liquid C2).

### (5) Preparation of Coating Liquid for Heat-Sensitive Recording Layer

29.5 parts of liquid A2, 63.6 parts of liquid B2, 45.5 parts of liquid C2, 70 parts of a 10% aqueous solution of completely saponified polyvinyl alcohol (trade name: PVA117, saponification: 99 mol %, average degree of polymerization: 1700, Produced by Kuraray Co., Ltd.), 20.8 parts of a styrene-butadiene-based copolymer latex (trade name: L-1571, produced by Asahi Kasei Corporation, solid concentration: 48%), 20 parts of calcium carbonate (trade name: Brilliant-15, produced by Shiraishi Kogyo Kaisha, Ltd., oil absorption: 56 ml/100 g), 2 parts of adipic acid dihydrazide (produced by Otsuka Chemical Co., Ltd.), and 150 parts of water were mixed and stirred, thus obtaining a coating liquid for a heat-sensitive recording layer.

### (6) Preparation of Coating Liquid for Protective Layer

A composition containing 317 parts of a 12% aqueous solution of diacetone-modified polyvinyl alcohol (trade name: DF-10, produced by Japan Vam & Poval Co., Ltd.), 60 parts of kaolin (trade name: Hydragloss 90, produced by KaMin LLC), 0.5 parts of polyethylene wax (trade name: Chemipearl W-400, produced by Mitsui Chemicals Inc.; solids content: 40%), 5 parts of zinc stearate (trade name: Hidorin Z-8-36, produced by Chukyo Yushi Co., Ltd.; solids content: 36%), and 300 parts of water was mixed and stirred, thus obtaining a coating liquid for a protective layer.

### (7) Production of Heat-Sensitive Recording Material

The coating liquid for an undercoat layer, the coating liquid for a heat-sensitive recording layer, and the coating liquid for a protective layer were applied in amounts after drying of 4.5 g/m², 3.8 g/m², and 2.3 g/m², respectively, to one surface of high-quality paper having a basis weight of 60 g/m², and dried to form an undercoat layer, a heat-sensitive recording layer, and a protective layer in this order. The obtained product was then super-calendered to smooth the surface, thus obtaining a heat-sensitive recording material.

### Example B2

A heat-sensitive recording material was obtained in the same manner as in Example B1, except that in the preparation of the coating liquid for a heat-sensitive layer of Example B1, aluminum hydroxide (trade name: Higilite H-42, produced by Showa Keikinzoku, oil absorption: 43 ml/100 g) was used instead of calcium carbonate.

### Example B3

A heat-sensitive recording material was obtained in the same manner as in Example B1, except that in the preparation of the coating liquid for a heat-sensitive layer of Example B1, clay (trade name: HG90, produced by KaMin LLC, oil absorption: 46 ml/100 g) was used instead of calcium carbonate.

### Example B4

A heat-sensitive recording material was obtained in the same manner as in Example B1, except that in the preparation of the coating liquid for a heat-sensitive layer of Example B1, the calcium carbonate (trade name: Brilliant-15, produced by Shiraishi Kogyo Kaisha, Ltd., oil absorption 56 ml/100 g) was changed to another calcium carbonate (trade name: Cal-Light-KT, produced by Shiraishi Kogyo Kaisha, Ltd., oil absorption: 120 ml/100 g).

### Example B5

A heat-sensitive recording material was obtained in the same manner as in Example B1, except that in the preparation of the coating liquid for an undercoat layer of Example B1, 79.2 parts of latex A were changed to 79.2 parts of latex B.

### Example B6

A heat-sensitive recording material was obtained in the same manner as in Example B1, except that in the preparation of the coating liquid for an undercoat layer of Example B1, 79.2 parts of latex A were changed to 79.2 parts of latex C.

### Example B7

A heat-sensitive recording material was obtained in the same manner as in Example B1, except that in the preparation of the coating liquid for an undercoat layer of Example B1, 100 parts of hollow particles A were changed to 100 parts of hollow particles B.

### Example B8

A heat-sensitive recording material was obtained in the same manner as in Example B1, except that in the preparation of the coating liquid for an undercoat layer of Example B1, the amount of calcined kaolin was changed to 66 parts from 38 parts, the amount of latex A was changed to 20.8 parts from 79.2 parts, and the amount of water was changed to 130 parts from 100 parts.

### Example B9

A heat-sensitive recording material was obtained in the same manner as in Example B1, except that in the preparation of the coating liquid for an undercoat layer of Example B1, the amount of calcined kaolin was changed to 66 parts from 38 parts, 79.2 parts of latex A were changed to 20.8 parts of latex C, 100 parts of hollow particles A were changed to 56.6 parts of hollow particles C, and the amount of water was changed to 180 parts from 100 parts.

### Comparative Example B1

A heat-sensitive recording material was obtained in the same manner as in Example B1, except that in the preparation of the coating liquid for a heat-sensitive layer of Example B1, amorphous silica (trade name: Nipsil E-743, produced by Tosoh Silica Corporation, oil absorption: 150 to 170 ml/100 g) was used instead of calcium carbonate.

### Comparative Example B2

### (8) Preparation of Developer Dispersion (Liquid D2)

40 parts of 4-hydroxy-4′-isopropoxy diphenyl sulfone (trade name: D-8, produced by Nippon Soda Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (liquid D).

A heat-sensitive recording material was obtained in the same manner as in Example B1, except that in the preparation of the coating liquid for a heat-sensitive layer of Comparative Example 1, developer dispersion liquid D2 was used instead of developer dispersion liquid B2.

The Examples and Comparative Examples were evaluated according to the following method. Table 2 shows the results.

### Recording Density

An image was recorded on each heat-sensitive recording material at applied energies of 0.16 mJ/dot (medium energy color density) using a thermal recording tester (trade name: TH-PMD, produced by Ohkura Electric Co., Ltd.). The printed portion was measured with a spectrodensitometer (X-Rite 504, produced by X-Rite). A larger value indicates a denser print.
The evaluation criteria for medium energy color density were the following.
A color density of 0.90 or higher: compatible with high-speed printing, very good
A color density of 0.80 or higher and lower than 0.90: needed for practical use
A color density of lower than 0.80: low sensitivity with many defects such as white spots, problematic in practical use

### Alcohol Resistance

A sample of each heat-sensitive recording material that had been subjected to color development using a label printer (trade name: L-2000, produced by Ishida Co., Ltd.) was immersed in a 75 volume % ethanol solution for 30 minutes. After this treatment, the optical density of the printed portion was measured with a spectrodensitometer (X-Rite 504, produced by X-Rite).
The evaluation criteria were the following.
A density of the post-treatment blank-paper portion of 1.00 or higher: very good
A density of the post-treatment blank-paper portion of 0.80 or higher and lower than 1.00: no problem in practical use
A density of the post-treatment blank-paper portion of lower than 0.80: printing is lost, which is problematic in practical use

### Plasticizer Resistance

A wrap film (trade name: Hi-S Soft, produced by Nippon Carbide Industries Co., Inc.) was wound around a polycarbonate pipe (diameter: 40 mm) three times, and a heat-sensitive recording material that had been subjected to color development using a label printer (trade name: L-2000, produced by Ishida Co., Ltd.) was placed on the film. A wrap film was further wound around the heat-sensitive recording material three times, and the wrapped heat-sensitive recording material was allowed to stand at 40° C. for 24 hours. After this treatment, the optical density of the recorded portion was measured with a spectrodensitometer (X-Rite 504, produced by X-Rite).
The evaluation criteria were the following.
A density of the post-treatment blank-paper portion of 1.00 or higher: very good
A density of the post-treatment blank-paper portion of 0.80 or higher and lower than 1.00: no problem in practical use
A density of the post-treatment blank-paper portion of lower than 0.80: printing is lost, which is problematic in practical use

### 100° C. Heat Resistance

A sample of each heat-sensitive recording material that had been subjected to color development using a label printer (trade name: L-2000, produced by Ishida Co., Ltd.) was allowed to stand in a chamber at 100° C. for 1 hour. After the treatment, the optical density of the blank-paper portion was measured with a spectrodensitometer (X-Rite 504, produced by X-Rite).
The evaluation criteria were the following.
A density of the post-treatment blank-paper portion of 0.10 or lower: very good
A density of the post-treatment blank-paper portion of higher than 0.10 and 0.20 or lower: no problem in practical use
A density of the post-treatment blank-paper portion of higher than 0.20: background fogging is too strong, which is problematic for practical use

TABLE 2

| | | Alcohol Resistance | | Plasticizer Resistance | | | |
|---|---|---|---|---|---|---|---|
| | Dynamic | (75% · 30 min) | | (40° C. · 24 H) | | 100° C. Heat Resistance | |
| | Color | | Printed | | Printed | | Blank-paper |
| | Sensitivity | Printed | Portion | Printed | Portion | Blank-paper | Portion |
| | 0.16 | Portion | (After | Portion | (After | Portion | (After |
| | (mJ/dot) | (Untreated) | Treatment) | (Untreated) | Treatment) | (Untreated) | Treatment) |
| Example B1 | 0.95 | 1.20 | 1.07 | 1.20 | 1.10 | 0.06 | 0.07 |
| Example B2 | 0.97 | 1.19 | 1.06 | 1.19 | 1.02 | 0.06 | 0.07 |
| Example B3 | 0.96 | 1.18 | 1.05 | 1.18 | 1.05 | 0.06 | 0.07 |
| Example B4 | 0.91 | 1.19 | 0.98 | 1.19 | 1.03 | 0.06 | 0.07 |
| Example B5 | 0.85 | 1.21 | 1.08 | 1.21 | 1.12 | 0.06 | 0.07 |
| Example B6 | 0.81 | 1.20 | 1.08 | 1.20 | 1.11 | 0.06 | 0.07 |
| Example B7 | 0.98 | 1.18 | 1.06 | 1.18 | 1.09 | 0.07 | 0.09 |
| Example B8 | 0.90 | 1.18 | 1.07 | 1.18 | 1.08 | 0.06 | 0.07 |
| Example B9 | 0.45 | 1.22 | 1.10 | 1.22 | 1.09 | 0.07 | 0.08 |
| Comparative | 0.92 | 1.18 | 0.75 | 1.18 | 0.45 | 0.06 | 0.07 |
| Example B1 | | | | | | | |
| Comparative | 1.18 | 1.25 | 0.12 | 1.25 | 0.68 | 0.08 | 1.21 |
| Example B2 | | | | | | | |

As can be seen from Table 2, the heat-sensitive recording materials of Examples B1 to B9 were excellent in alcohol resistance and plasticizer resistance, as well as excellent in thermal background fogging resistance. In contrast, Comparative Example B1 was poor in alcohol resistance of printing, and significantly poor in plasticizer resistance. Due to the change of the developer, Comparative Example B2 was significantly poor in alcohol resistance, while being slightly better than Comparative Example B1 in plasticizer resistance, but was not suitable for practical use. Additionally, the density of the blank-paper portion was significantly poor in 100° C. heat resistance.

1: A heat-sensitive recording material comprising at least an undercoat layer and a heat-sensitive recording layer in this order on a support,
the undercoat layer containing hollow particles, a binder, and an inorganic pigment I,
the heat-sensitive recording layer containing a leuco dye and a developer, wherein
(A) the heat-sensitive recording layer contains 5-(N-3-methylphenyl-sulfonamide)-N′,N″-bis-(3-methylphenyl)-isophthalic acid diamide as a stability improver, or
(B) the heat-sensitive recording layer contains 5-(N-3-methylphenyl-sulfonamide)-N′,N″-bis-(3-methylphenyl)-isophthalic acid diamide as the developer and contains a pigment with an oil absorption of 130 ml/100 g or less as an inorganic pigment II.

2: The heat-sensitive recording material according to claim 1, wherein (A) the heat-sensitive recording layer contains 5-(N-3-methylphenyl-sulfonamide)-N′,N″-bis-(3-methylphenyl)-isophthalic acid diamide as the stability improver.

3: The heat-sensitive recording material according to claim 2, wherein the developer is a diphenylsulfone derivative represented by the following formula (1): 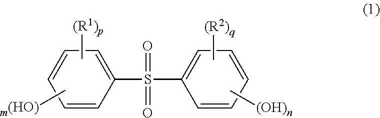
wherein R¹ and R² are the same or different and represent a C₁₋₄ alkyl group, a C₂₋₄ alkenyl group, a C₁₋₄ alkoxy group, a C₂₋₄ alkenyloxy group, a C₇₋₁₂ aralkyloxy group, or a halogen atom, m represents an integer of 0 to 2, n represents an integer of 1 to 3, and p and q are the same or different and represent an integer of 0 to 2.

4: The heat-sensitive recording material according to claim 3, wherein the diphenylsulfone derivative represented by formula (1) is at least one member selected from the group consisting of 4-hydroxy-4′-isopropoxy diphenyl sulfone, 4,4′-dihydroxydiphenyl sulfone, 2,4′-dihydroxydiphenyl sulfone, bis(3-allyl-4-hydroxy)diphenyl sulfone, 4-hydroxyphenyl(4′-n-propoxyphenyl) sulfone, 4-allyloxy-4′-hydroxydiphenyl sulfone, and 4-hydroxy-4′-benzyloxydiphenyl sulfone.

5: The heat-sensitive recording material according to claim 2, wherein the developer is N-p-tolylsulfonyl-N′-3-(p-tolylsulfonyloxy)phenylurea.

6: The heat-sensitive recording material according to claim 2, wherein the developer is N-[2-(3-phenylureid)phenyl]benzenesulfonamide.

7: The heat-sensitive recording material according to claim 1, wherein (B) the heat-sensitive recording layer contains 5-(N-3-methylphenyl-sulfonamide)-N′,N″-bis-(3-methylphenyl)-isophthalic acid diamide as the developer and a pigment with an oil absorption of 130 ml/100 g or less as the inorganic pigment II.

8: The heat-sensitive recording material according to claim 7, comprising at least one member selected from the group consisting of calcium carbonate, aluminum hydroxide, and clay as the inorganic pigment II.

9: The heat-sensitive recording material according to claim 7, comprising a pigment with an oil absorption of 130 ml/100 g or less as the inorganic pigment I.

10: The heat-sensitive recording material according to claim 7, comprising at least one member selected from the group consisting of calcium carbonate, aluminum hydroxide, and clay as the inorganic pigment I.

11: The heat-sensitive recording material according to claim 7, wherein the heat-sensitive recording layer contains as a second developer at least one member selected from the group consisting of
a urea urethane compound represented by the following formula (2): 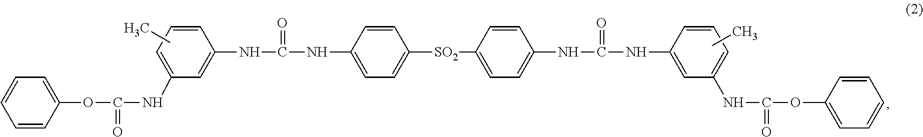
a crosslinked dephenyl sulfone compound represented by the following formula (3): 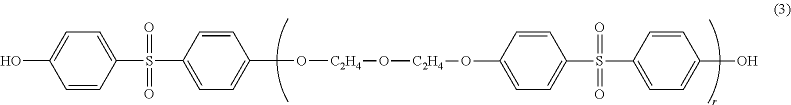
wherein r represents an integer of 1 to 6,
an N,N′-diarylurea-based compound represented by the following formula (4): 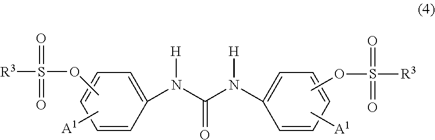
wherein R³ represents a C₁₋₁₂ alkyl group, a C₇₋₁₂ aralkyl group, or a C₆₋₁₂ aryl group, the aralkyl group and aryl group may optionally be substituted with a C₁₋₁₂ alkyl group, a C₁₋₁₂ alkoxy group, a C₆₋₁₂ aryl group, or a halogen atom, a plurality of R³s may be the same or different, A¹ represents a hydrogen atome or a C₁₋₄ alkyl group, a plurality of A¹s may be the same or different,
a compound represented by the following formula (5): 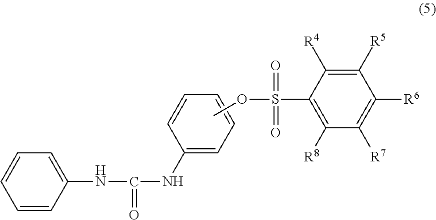
wherein R⁴ to R⁸ are the same or different and represent a hydrogen atom, a halogen atom, a nitro group, an amino group, an alkyl group, an alkoxy group, an aryloxy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group, and
4,4′-bis(3-tosylureid)diphenylmethane.

12: The heat-sensitive recording material according to claim 1,
wherein
the hollow particles have a maximum particle diameter (D100) of 10 to 30 μm and an average particle diameter (D150) of 4.0 to 15 μm,
the ratio of the maximum particle diameter (D100) to the average particle diameter (D50), which is D100/D50, is 1.8 to 3.0, and
the volume % of particles with a particle diameter of 2.0 μm or less is 1% or less.

13: The heat-sensitive recording material according to claim 1, wherein the hollow particles have a hollow ratio of 80 to 98%.

14: The heat-sensitive recording material according to claim 1, wherein the binder in the undercoat layer contains a binder resin with a glass transition temperature of −10° C. or lower.

15: The heat-sensitive recording material according to claim 1, further comprising an adhesive layer on at least one surface of the support.
